(19) United States
(12) Patent Application Publication
(10) Pub. No.: US 2010/0031004 A1
(43) Pub. Date: Feb. 4, 2010

(54) ARITHMETIC DEVICE

(75) Inventor: Masami NAKAJIMA, Tokyo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 12/480,321

(22) Filed: Jun. 8, 2009

(30) Foreign Application Priority Data
Aug. 1, 2008 (JP) 2008-199789

(51) Int. Cl. G06F 15/76; G06F 9/02

(52) U.S. Cl. 712/36; 712/E09.002

(57) ABSTRACT

To reduce the size of a basic block composed of a plurality of arithmetic & logical processing unit blocks, and achieve high-speed operation.

Unit blocks are arranged in a matrix and adjacent unit blocks are coupled. For the unit blocks arranged in a matrix, serial block numbers are assigned so as to form a closed loop curve. In a boundary region of minimum dividable unit blocks, selectors are arranged at input ports of the unit blocks, and the output wiring of the unit block in the boundary region is coupled to the input selectors of the adjacent unit block and an opposing unit block. A block size of a basic block is changed by switching a coupling path of the selector.

### CROSS-REFERENCE TO RELATED APPLICATION

The disclosure of Japanese Patent Application No. 2008-199789 filed on Aug. 1, 2008 including the specification, drawings and abstract is incorporated herein by reference in its entirety.

### BACKGROUND OF THE INVENTION

The present invention relates to a parallel arithmetic device, and particularly, to the arrangement of processors (processing devices) in order to improve the extensibility (scalability) of the parallel arithmetic device in which a plurality of processors (processing devices) performs processings in parallel.

In recent years, with the spread of handheld terminal devices, importance of digital signal processing which processes a large amount of data such as audio and images at a high speed is increasing. Generally, a DSP (Digital Signal Processor) is used for digital signal processing as a dedicated semiconductor device. The DSP includes a register and an arithmetic & logical processing unit, and can perform a single arithmetic processing in a single clock cycle. However, since the data is processed sequentially, it is difficult to improve the processing performance drastically even if a dedicated DSP is used when there is a very large amount of data to be processed. For example, when there are 10000 sets of data to be processed, at least 10000 cycles are required for the processing assuming that processing of individual data is performed in one machine cycle. In other words, although individual processing is fast, the processing time increases with the increase of data amount, because data processing is performed sequentially.

When there is a large amount of data to be processed, it is possible to improve the processing performance by parallel processing. In other words, data processing is performed in parallel by preparing a plurality of core processors and operating the core processors in parallel. Multi-core systems using the core processors include SIMD (single instruction stream multiple data stream) which performs an identical processing on a plurality of data, and MIMD (multiple instruction stream multiple data stream) which performs different processing on a plurality of data.

An exemplary configuration of an SIMD parallel arithmetic device is described in Patent Document 1 (Japanese patent laid-open No. 2006-127460), for example. In the configuration described in the Patent Document 1, a plurality of arithmetic processing elements is provided in parallel, and memory cell entries are provided corresponding to the arithmetic processing elements. The data to be processed are stored in these entries and arithmetic processing is performed on each entry in a bit-serial mode. Bit-serial mode is a mode which processes multiple-bit data on a one-by-one basis.

Since arithmetic processing of multiple bit data is performed on an individual-bit basis, the processing time of a single data to be processed is defined by its bit width. However, since data of a plurality of entries to be processed are parallely processed in corresponding processing unit, the arithmetic processing speed can be improved as a result. For example, if one machine cycle is assigned to loading the data to be processed into the processing unit, processing; and storing the processing result, a bit-serial mode of processing requires 4×N machine cycles to process each of the entries, where N is the bit width of a data word (when data a and b to be processed are both stored together in each entry and the bits of data a and b are sequentially loaded). If M entries are provided, the result of processing M data can be obtained in 4×N machine cycles in terms of arithmetic processing time.

When M sets of N-bit data are sequentially processed, M machine cycles are required to obtain the result of arithmetic processing. Typically, the data to be processed has 32 to 64 bits. Thus, if the number of entries M is larger than the data bit width, for example 128, processing time can be reduced by parallel processing. In particular, the larger the number of entries M grows, the more significantly the processing performance is enhanced. For example, if the number of entries M is 1024 and data bit width N is 8-bit, the processing time required for arithmetic processing of one entry is 4×8=32 machine cycles, whereby the result of processing for 1024 data sets can be obtained in these 32 machine cycles.

Additionally, another configuration of a multi-core processor is described in a Non-Patent Document 1 (S. Bell, et al., “TILE64 Processor: A 64-Core SoC with Mesh Interconnect,” ISSCC Dig. Tech. Papers, pp. 88-89, February 2008) where a tile-shaped processor cores, which are referred to as tiles, are arranged in a matrix, and data communication buses are provided in a lattice between the processor cores which are arranged in a matrix. In the tile processor (processor core) described in the Non-Patent Document 1, a processor, a cache memory, and a switch for switching communication paths (router) are provided in each of the tiles.

The tile processors are interconnected by a wiring arranged in a mesh. Only adjacent tile processors are interconnected by the wiring to perform information processing in a mesh-network-like communications network. Therefore, it is considered to avoid the problem of wiring delay that occurs when the circuit size is increased, and suppress decrease of operation speed. In addition, since the wiring between the tile processors (core processors) is limited to between adjacent tile processors, it is not necessary to arrange wire connection paths for communication between all of the processors, and thereby increase of wiring area is suppressed.

In addition, an arrangement of arranging the core processors in a matrix as tiles is also described in Non-Patent Document 2 (S. Vangal, et al., “An 80-Tile 1.28 TFLOPS Network-on-Chip in 65 nm CMOS,” ISSCC Dig. Tech. Papers, pp. 98-99, February, 2007). In the configuration described in the Non-Patent Document 2, each tile comprises a processor element and a router. A wiring is provided in a mesh for the tile processors, and transfer of data/instructions is performed by a router in each tile processor. The router within the tile processor allows internal access and data communication to the communication bus arranged on the reflection tile from top to bottom and side to side (north, south, east and west). The router not only allows communication between adjacent processors but also communication between tile processors along the shortest route, and routing such as circumventing a particular tile. Also in the configuration described in the Non-Patent Document 2, processing is performed with the tile processors linked in a pipeline manner between adjacent unit processors. By linking adjacent tile processors, it is expected to run a plurality of pipelines in parallel, while suppressing the wiring delay to a minimum.

The performance required for a processing device differs depending on the application of the processing. Generally, processing devices of a plurality of types of specifications are prepared and the processing unit most suitable for the application is selected and used.

Designing processing devices according to individual specifications to configure arithmetic devices of different specifications in order to cope with such demands for a plurality of types of specifications results in a lower design efficiency and accordingly a lower yield. Therefore, it is desirable from the viewpoint of design efficiency and yield to prepare a basic configuration having an optimized performance as a library (macro) and satisfy the required specifications by selectively using the library (macro) according to the required specification.

The configuration described in the above-mentioned Patent Document 1 provides a configuration in which a plurality of basic blocks (main arithmetic circuits) having a plurality of processing elements arranged in parallel is coupled to an internal data bus in parallel. The basic blocks are interconnected by a wiring between adjacent blocks in a loop. By interconnection of the basic blocks by a wiring between adjacent blocks, faster data transfer between the basic blocks (main arithmetic circuits) and additionally, extension of the processing system are achieved.

However, the configuration of the Patent Document 1 only describes the configuration of a basic block (main arithmetic circuit) in which respective processing elements of adjacent blocks are interconnected by a wiring between adjacent blocks in a loop. In such a case, there is a possibility that the degree of freedom of arranging the basic blocks may be restricted as described below. In other words, when increasing the circuit size using a plurality of basic blocks, it is difficult to realize a configuration of arranging the basic blocks densely in a matrix while maintaining the wiring between blocks in a loop, thus it is conceivable that there is still room for improvement from the viewpoint of extensibility. On the contrary, when a large scale processing system is constructed using many basic blocks, it becomes difficult to divide the system into smaller processing systems while maintaining the system configuration and the arrangement of the wiring between the blocks. When constructing a large scale system which can be divided into smaller systems, it is necessary to provide a wiring between basic blocks depending on the assumed arrangement of the smaller systems, thereby increasing the area occupied by the wiring and additionally it is necessary to dispose a circuit to change the system scale according to each wiring thereby increasing the area.

Additionally, in a case where tile processors such as those shown in the Non-Patent Documents 1 and 2 are used as processor cores and the processor cores are arranged in a matrix to constitute a multiprocessor system, a required number of tile processors (core processors) are optimally arranged according to the required specification. The Non-Patent Documents 1 and 2 take no consideration of changing the scale of these multi-core processors according to the required specification, i.e., changing the arrangement of the tile processors inside.

In the configuration described in the Non-Patent Documents 1 and 2, a communication path between tile processors can be freely provided inside the multiprocessor by a router provided in the tile processors. However, if an arrangement is provided inside to use the multiprocessor itself as a large-scale processor or a small-scale processor, it is necessary to arrange mesh-like wirings (networks) for coupling to a router of the adjacent tile processor, respectively, according to the required scale, thereby increasing the area occupied by the wiring. Additionally, it is conceived that a problem occurs such that a switch arrangement becomes necessary to switch the wiring path according to the scale, and the area occupied by the switch increases as well.

Therefore, it is an object of the present invention to provide a parallel arithmetic device which can easily change the circuit size of a multiprocessor-type parallel arithmetic device without increasing the area occupied by the wiring or increasing the internal wiring delay.

### SUMMARY OF THE INVENTION

The parallel arithmetic device according to the present invention comprises a basic block having unit blocks arranged in an array in a first direction and a second direction. The basic block can be divided into minimum dividable basic blocks. A selector is provided corresponding to each unit block between the minimum dividable blocks in the first direction. The selectors provided for unit blocks adjacently arranged in the first and second directions are coupled by wiring. The coupling path of the selectors is changed depending on the block size.

### EFFECT OF THE INVENTION

A selector is provided in the boundary region of the minimum dividable basic blocks and the wire connection path is switched by the selector according to the block size. Adjacent unit block are coupled in the minimum dividable basic block by wiring. Thus, wiring between unit blocks is provided only between the adjacent unit blocks regardless of the block size, and thereby the layout area of the wiring can be reduced and signal propagation delay due to the wiring delay can also be reduced.

In addition, only by switching the coupling path of the minimum dividable basic blocks, a plurality of the minimum dividable basic blocks can be arranged to extend the size of the parallel arithmetic device, or inversely the size of the parallel arithmetic device can be reduced, and thereby scalability can be improved.

### BRIEF DESCRIPTION OF THE DRAWINGS

FIG. 1 is a diagram schematically illustrating an overall configuration of a parallel arithmetic device according to an embodiment 1 of the present invention;

FIG. 2 is a diagram schematically illustrating a configuration of an inter-ALU coupling switching circuit of the parallel arithmetic device shown in FIG. 1;

FIG. 3 is a diagram illustrating more specifically a wiring layout of the inter-ALU coupling switching circuit shown in FIG. 1;

FIG. 4 is a diagram schematically illustrating an exemplary configuration of an upshifter and a downshifter shown in FIG. 2;

FIG. 5 is a diagram illustrating an exemplary configuration of the upshifter and the downshifter shown in FIG. 2;

FIG. 6 is a diagram schematically illustrating an exemplary configuration of a processing element shown in FIG. 1;

FIG. 7 is a diagram schematically illustrating an arithmetic processing mode of the processing element shown in FIG. 6;

FIG. 8 is a diagram schematically illustrating a configuration of the minimum dividable basic block of the parallel arithmetic device according to the embodiment 1 of the present invention;

FIG. 9 is a diagram schematically illustrating a layout of the wiring of the inter-ALU coupling switching circuit shown in FIG. 8;

FIG. 10 is a diagram schematically illustrating a coupling path for an 8-down-block configuration of the parallel arithmetic device according to the embodiment 1 of the present invention;

FIG. 11 is a diagram schematically illustrating a data transmission path for the 8-unit-block configuration of the parallel arithmetic device shown in FIG. 10;

FIG. 12 is a diagram schematically illustrating a coupling path for a 16-unit-block configuration according to the embodiment 1 of the present invention;

FIG. 13 is a diagram schematically illustrating a data propagation path for the 16-unit-block configuration of the parallel arithmetic device shown in FIG. 12;

FIG. 14 is a diagram schematically illustrating an arrangement mode of unit blocks of a basic arithmetic block in the embodiment 1 of the present invention;

FIG. 15 is a diagram illustrating the coupling path of unit blocks, together with their block numbers, of the parallel arithmetic device according to the embodiment 1 of the present invention;

FIG. 16 is a diagram schematically illustrating an exemplary variation of the configuration of the parallel arithmetic device according to the embodiment 1 of the present invention;

FIG. 17 is a diagram illustrating, in a simplified manner, a wire connection of the configuration shown in FIG. 16;

FIG. 18 is a diagram illustrating an exemplary coupling state of the parallel arithmetic device shown in FIG. 17;

FIG. 19 is a diagram schematically illustrating the coupling mode of unit blocks for the coupling configuration shown in FIG. 18;

FIG. 20 is a diagram schematically illustrating the coupling mode of the wiring and data propagation path for the configuration shown in FIG. 16;

FIG. 21 is a diagram illustrating the coupling mode of unit blocks for the coupling of the data propagation path shown in FIG. 20;

FIG. 22 is a diagram schematically illustrating a coupling mode of unit blocks for yet another block configuration in the arrangement shown in FIG. 17;

FIG. 23 is a diagram schematically illustrating the coupling path for the 16-block configuration of exemplary variation of the embodiment 1 of the present invention;

FIG. 24 is a diagram schematically illustrating the unit block coupling path for the 16-block configuration in the arrangement shown in FIG. 23;

FIG. 25 is a diagram schematically illustrating the block coupling mode of the coupling path shown in FIG. 24;

FIG. 26 is a diagram schematically illustrating the block coupling mode for a 32-block extension of the arrangement shown in FIG. 24;

FIG. 27 is a diagram illustrating an exemplary variation of the block coupling mode for the 32-block configuration of the arrangement shown in FIG. 24;

FIG. 28 is a diagram schematically illustrating the block coupling mode for a 64-block configuration of the exemplary variation of the embodiment 1 of the present invention;

FIG. 29 is a diagram schematically illustrating the block coupling mode for the 8-block coupling of the block coupling mode shown in FIG. 28;

FIG. 30 is a diagram schematically illustrating the configuration of the basic block of a parallel arithmetic device according to an embodiment 2 of the present invention;

FIG. 31 is a diagram schematically illustrating the coupling path for the 16-block configuration according to the configuration shown in FIG. 30;

FIG. 32 is a diagram schematically illustrating an arrangement of selectors of the exemplary variation of the embodiment 2 of the present invention;

FIG. 33 is a diagram schematically illustrating the configuration of a parallel arithmetic device according to an embodiment 3 of the present invention;

FIG. 34 is a diagram schematically illustrating the configuration of an exemplary variation of the unit block of the embodiment 3 of the present invention;

FIG. 35 is a diagram schematically illustrating an exemplary configuration of a processor core shown in FIG. 34;

FIG. 36 is a diagram schematically illustrating a configuration of yet another exemplary variation of the unit block according to the embodiment 3 of the present invention;

FIG. 37 is a diagram schematically illustrating an arrangement of the selectors for the basic block configuration according to an embodiment 4 of the present invention;

FIG. 38 is a diagram schematically illustrating the configuration of a unit block of the parallel arithmetic device according to the embodiment 4 of the present invention;

FIG. 39 is a diagram schematically illustrating an arrangement of the selectors of the configuration shown in FIG. 38; and

FIG. 40 is a diagram schematically illustrating an exemplary coupling mode for the 16-unit-block configuration of the parallel arithmetic device shown in an embodiment of the present invention.

### DETAILED DESCRIPTION OF THE PREFERRED EMBODIMENTS

### Embodiment 1

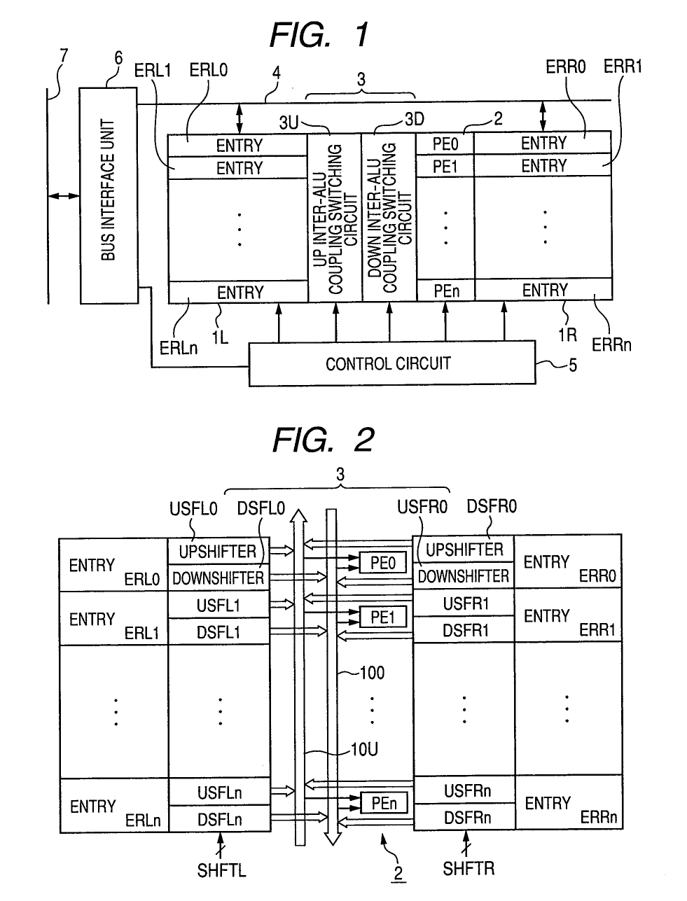

FIG. 1 schematically illustrates an exemplary configuration of a unit block of a parallel arithmetic device according to an embodiment 1 of the present invention. In FIG. 1, the unit block includes data register circuits 1L and 1R which store data, and a processing unit 2 which performs processing of the data stored in the data register circuits 1L and 1R in parallel. The data register circuit 1L includes a plurality of entries ERL0-ERLn, and the data register circuit 1R also includes a plurality of entries ERR0-ERRn. The entries ERL0-ERLn and ERR0-ERRn, which have memory cells respectively arranged in n-bit width, store the data to be processed and the processing result data, respectively.

The processing unit 2 includes processing elements (processor cores) PE0-PEn provided corresponding to each of the entries ER0, ERR0-ERLn and ERRn. Each of these processing elements (processor cores) PE0-PEn has a function of performing addition, subtraction, NOT operation, AND operation, OR operation, and XOR operation, and performs a specified arithmetic processing on provided data. In the arithmetic processing, a set of data to be processed is transferred to the processing elements PE0-PEn in bit units from the entries ERL0-ERLn and ERR0-ERRn of the data register circuits 1L and 1R, and the results of processing for each bit are stored in the specified entries, respectively.

Since the processing elements PE0-PEn perform the arithmetic processing in parallel, arithmetic processing even in a bit-serial mode can be performed with a high-speed by increasing the number of the entries.

In the processing unit 2, an up inter-ALU coupling switching circuit 3D and a down inter-ALU coupling switching circuit 3U are provided as inter-ALU coupling switching circuits 3. The inter-ALU coupling switching circuits 3U and 3D switch the data transfer path between the processing elements PE0-PEn included in the processing unit 2.

The up inter-ALU coupling switching circuit 3U forms a data transfer path from the processing element PEn toward the processing element PE0, and the down inter-ALU coupling switching circuit 3D forms a data transfer path from the processing element PE0 toward the processing element PEn. These inter-ALU coupling switching circuits 3U and 3D can switch the data transfer path for processing elements separated by one, two, four entries, . . . , respectively. Thus, the result of arithmetic processing in the processing element PE0, for example, can be transferred to the processing element PEn.

This unit block further includes a control circuit 5 and a bus interface unit 6 provided therein. An instruction memory is provided in the control circuit 5, and according to an instruction stored in the instruction memory, the control circuit 5 performs loading/storing of data from and to the data register circuits 1L and 1R, assigns the processing bit position, and also specifies the processing in the processing unit 2. Additionally, the control circuit 5 defines the coupling path of the inter-ALU coupling switching circuits 3U and 3D.

The bus interface unit 6 performs data transfer between an external data bus 7 and an internal data bus 4. Writing/reading of data into and from the data register circuits 1L and 1R are performed via the internal data bus 4. The bus interface unit 6 may have an orthogonal transformation circuit provided therein to transform the arrangement of the data. The orthogonal transformation circuit transforms a bit-serial and word-parallel data stream on the internal data bus 4 into a bit-parallel and word-serial data stream. “Bit serial and word parallel” indicates a mode in which bits on an identical position of a plurality of words are transferred/processed in parallel and “bit parallel and word serial” indicates a mode in which data bits constituting a word are transferred/processed in parallel per word unit.

In FIG. 1, although a selection circuit (line selection circuit) is arranged to select a bit of entries of the data register circuits 1L and 1R, it is not shown in FIG. 1 for simplicity. Typically, a word Line is arranged in common for a plurality of entries and a bit line is arranged for each entry, wherein the bit line is used as a data transfer path between a selection bit (memory cell) of an entry and the corresponding processing element.

FIG. 2 schematically illustrates the configuration of the inter-ALU coupling switching circuit 3 shown in FIG. 1. In FIG. 2, an upshift bus 10U and a downshift bus 10D are provided in the inter-ALU coupling switching circuit 3. These shift buses 10U and 10D have a bit width twice the number of the entries, i.e., a bit width of 2*(n+1), which are coupled to the processing elements PE0-PEn in a one to one manner.

A set of upshifters and downshifters is provided corresponding to each of the entries ERL0-ERLn. In other words, upshifters USFL0-USFLn are provided for the entries ERL0-ERLn, and according to a shift control signal SFTL, the corresponding entries ERL0-ERLn are coupled via the upshift bus 10U to processing elements separated by a specified number of entries. The shift width is determined by the shift control signal SHFTL. Similarly, downshifters DSFL1-DSFLn are provided corresponding to the entries ERL0-ERLn and similarly, according to the shift control signal SHFTL, corresponding entries ERL0-ERLn are shifted down by a specified number of bits and coupled to corresponding processing elements via the downshift bus 10D.

Up-shifters USFR0-USFRn and downshifters DSFR0-DSFRn are also provided corresponding to entries ERR0-ERRn, respectively. According to the shift control signal SHFTR, the upshifters USFR0-USFRn couple the entries ERR0-ERRn to a processing element at a position shifted up by a specified number of entries, via the upshift bus 10U. According to the shift control signal SHFTR, the downshifter DSFR0-DSFRn similarly couple the entries ERR0-ERRn to a processing element at a position shifted down by a specified number of entries, via the downshift bus 10D.

The upshifters USFL0-USFLn and USFR0-USFRn, and the upshift bus 10U correspond to the up inter-ALU coupling switching circuit 3U shown in FIG. 1, and the downshifters DSFL0-DSFLn and DSFR0-DSFRn, and the downshift bus 10D correspond to the down inter-ALU coupling switching circuit 3D shown in FIG. 1.

By using the inter-ALU coupling switching circuit 3, data transfer between the entries can be performed in a unit block.

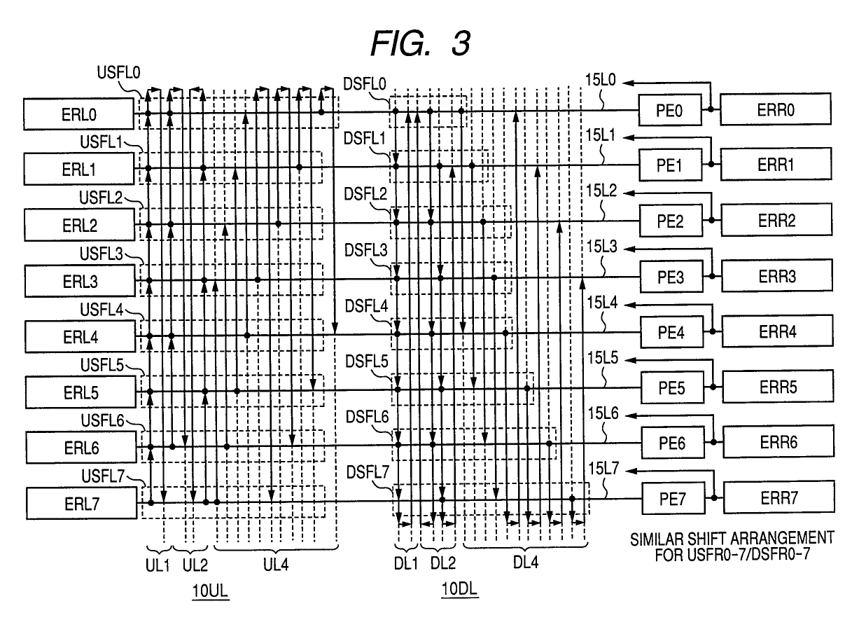

FIG. 3 schematically illustrates an exemplary configuration of the upshifters USFL0-USFLn and the downshifters DSFL0-DSFLn shown in FIG. 1. In FIG. 3, the configuration of the upshifters and the downshifters is schematically illustrated when eight entries ERR0-ERR7 are provided as the entries.

A left-side upshift data bus 10UL is provided corresponding to the upshifters USFL0-USFL7 in the upshift bus 10U. The upshifters USFL0-USFL7 perform 0-bit, 1-bit, 2-bit and 4-bit upshift operations, respectively. In the left-side upshift data bus 10L, a wiring is provided according to the number of shift entries, as shown by the arrow in FIG. 3. In FIG. 3, a “” mark shows the source of data transfer and the arrow shows the destination of the data transfer. Here, the configuration of the part which performs the 0-bit shift is not shown in FIG. 3. Details of the configuration of the shifter will be described below, in which an internal data output line is provided corresponding to each entry, and the data of a corresponding entry on the internal data output line is transferred via the shift bus. For simplicity, the internal data output line is not shown in FIG. 3.

Internal data transfer lines 15L0-15L7 are provided for respective entries ERL0-ERL7, and the internal data transfer lines 15L0-15L7 are joined with the processing elements PE0-PE7, respectively. The data from corresponding entries are upshifted by 0, 1, 2 and 4 bits and transferred to corresponding processing elements via the data transfer lines 15L0-15L7. Here, at the time of a 0-bit shift operation, a corresponding entry ERL1 is coupled to a corresponding processing element PEi via an internal data line 15Li.

In the left-side upshift data bus 10UL, a 1-bit upshift bus UL1, a 2-bit upshift bus UL2, and a 4-bit upshift bus UL4 are provided. Up-shifters USFL0-USFL7 are provided corresponding to the intersection of these upshift buses UL1, UL2 and UL4, and the internal data transfer lines 15L0-15L7.

The 1-bit upshift bus UL1 transfers the data of the entries ERL7-ERL0 to the internal data transfer line provided for the entries ERL6-ERL0 and ERL7. Here, shift operation of the data is performed in a cyclic manner in a single block at the time of the shift operation.

In the 2-bit upshift bus UL2, data of the entries ERL7-ERL7 are shifted up by two entries and transferred to the internal data lines provided corresponding to the entries ERL5-ERL0 respectively, data of the entry ERL1 is transferred to the internal data line 15L7 provided corresponding to the entry ERL7, and data of the entry ERL0 is transferred to the internal data line 15L6 provided corresponding to the entry ERL6.

In the 4-bit upshift bus UL4, data is transferred to an entry separated by one entry. In other words, the data of the entries ERL7-ERL4 are transferred to the entries ERL3-ERL0, respectively. Data of the entries ERL3-ERL0 are transferred to the entries ERL7-ERL4, respectively.

In the upshift data bus 10UL, the wiring is provided in a continuously extending manner, and wire connection is selectively formed according to the number of required shift entries, thereby forming a shift path.

Similarly in the downshift bus 10DL, a left downshift data bus 10DL is provided corresponding to the left-side entries ERL0-ERL7. Similarly in the left downshift data bus 10DL, a 1-entry downshift bus DL1, a 2-entry downshift bus DL2, and a 4-entry downshift bus DL4 are provided. Down-shifters DSFL0-DSFL7 are provided corresponding to the intersection of the downshift buses DL1-DL4 and the internal data transfer lines 15L0-15L7.

Similarly in the downshifters DSFL0-DSFL7, the source of transfer is indicated by the “” mark and the destination of the transfer is indicated by an arrow in the data transfer path. Similarly in each of these downshifters DSFL0-DSFL7, a 1-entry shift element, a 2-entry shift element, and a 4-entry shift element are provided, which respectively perform data transfer to entries separated downward by one, two and four entries. Since this downshift data transfer mode is similar to the shift operation in the above-mentioned upshifters USFL0-USFL7 except that only the transfer direction is opposite, detailed description thereof is omitted.

In the 1-entry downshift bus DSL 1, data is transferred to the internal data line corresponding to an entry adjacent in the downward direction of the figure; in the 2-entry shift bus, data is transferred to the internal data line corresponding to an entry separated by one entry in the downward direction of the figure; and in the 4-entry shift bus DL4, data can be transferred to the internal data line provided corresponding to an entry separated by three entries in the downward direction of the figure. In other words, at the time of the 4-entry downshifting, data can be transferred from the entry ERLi to the entry ERL (i+4). Here, is in the range of 0 to 7 and (i+4) is provided by a modulo-7 operation. Similarly, at the time of the downshifting, shift operation of data is performed in a cyclic manner.

Entries ERR0-ERR7 are provided corresponding to the processing elements PE0-PE7 and similarly, upshift and downshift wirings are provided for the upshifters ESFR0-ESFR7 and the downshifters DSFR0-DSFR7 provided in the entries ERR0-ERR7.

The layout of shift wirings of the upshifters USFR0-USFR7 and the downshifters DSFR0-DSFR7 provided in the right-side entries ERR0-ERR7 are not shown in FIG. 3.

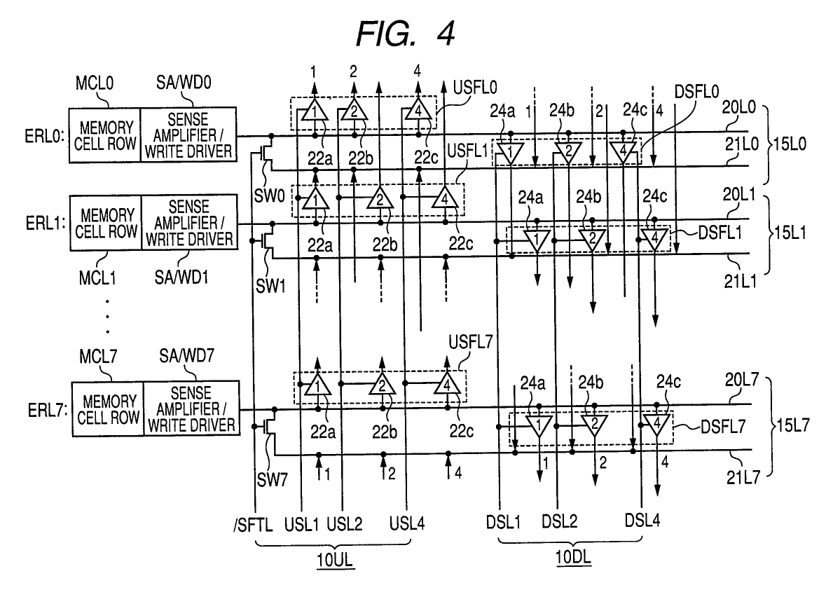

FIG. 4 illustrates more specifically the configuration of the upshifters USFL0-USFL7 and the downshifters DSFL0-DSFL7 shown in FIG. 3. In FIG. 4, the configuration of the entries ERL0-ERL7 is shown together.

The entries ERL0-ERL7 respectively have memory cell rows MCL0-MCL7 and sense amplifiers/write drivers SA/WD0-SA/WD7. The memory cell rows MCL0-MCL7 have memory cells including a plurality of bits arranged in an array in the extending direction of the entries. The memory cells include SRAM (static random access memory) cells, for example.

Each of the sense amplifiers/write drivers SA/WD0-SA/WD7 includes a sense amplifier for data reading and a write driver for data writing, wherein the sense amplifier and the write driver respectively read and write data from and into a selected memory cell of corresponding memory cell rows MCL0-MCL7.

Internal data transfer lines 15L0-15Ln are provided in correspondence with each of these sense amplifiers/write drivers SA/WD0-SA/WD7. The internal data transfer lines 15L0-15L7 respectively have a group of first data transfer lines 20L0-20L7 and second data transfer lines 21L0-21L7. The first data transfer lines 20L0-20L7 are selectively coupled to the corresponding second data transfer lines 21L0-21L7, respectively, by switching elements SW0-SW7. Each of these switching elements SW0-SW7 is turned into a non-conductive state when the shift instruction signal/SFTL is activated. The shift instruction signal/SFTL is set to L-level active state at the time of the shift operation. The 0-bit shift operation is realized by the switching elements SW0-SW7.

These first data transfer lines 20L0-20L7 are also coupled, as will be described below, to the output part of each of the processing elements PE0-PE7.

Each of the upshifters USFL0-USFL7 includes a 1-entry shift driver 22a, a 2-entry shift driver 22b, and a 4-entry shift driver 22c. These shift drivers 22a, 22b and 22c are selectively activated according to shift instruction signals USL1-USL2 and USL4, respectively, and couple the data on the corresponding first data transfer lines 20L0-20L7 to the second data transfer lines 21L0-21L7 of corresponding entries. In FIG. 4, the number of shift entries is shown at the side of the driver output lines.

Each of the downshifters DSFL0-DSFL7 includes a 1-entry downshift driver 24a, a 2-entry downshift driver 24b, and a 4-entry downshift driver 24c. These downshift drivers 24a, 24b and 24c are selectively activated according to downshift instruction signals DSL 1, DSL 2 and DSL 4, respectively, and couple the corresponding first data transfer lines 20L0-20L7 to the second data transfer lines 21L0-21L7 provided corresponding to the specified entries.

In FIG. 4, a configuration of the left-side upshift data bus 10UL and the left-side downshift data bus 10DL is shown representatively. Here, a similar configuration for the upshifters USR0-USR7 and the downshifters DSR0-DSR7 on the right-side is provided as described below.

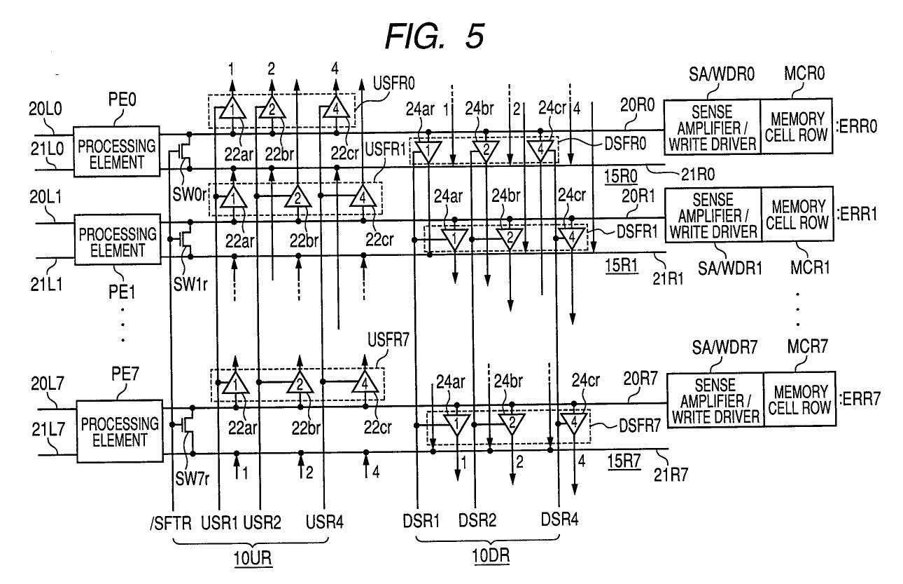

FIG. 5 schematically illustrates an exemplary configuration of upshifters USFR0-USFR7 and downshifters DSFL0-DSFL7 provided on the right-side entries ERR0-ERR7.

The entries ERR0-ERR7 also include memory cell rows MCR0-MCR7 and sense amplifiers/write drivers SA/WDR0-SA/WDR7, respectively. In the memory cell rows MCR0-MCR7, memory cells are arranged in an array, similarly with the memory cell rows MCL0-MCL7 shown in FIG. 4. The sense amplifiers/write drivers SA/WDR0-SA/WDR7 read and write data from and into a selected memory cell of the corresponding memory cell rows MCR0-MCR7.

First data transfer lines 20R0-20R7 are provided corresponding to each of the sense amplifiers/write drivers SA/WDR0-SA/WDR7, and second internal data transfer lines 21R0-21R7 are provided in parallel with the first internal data transfer lines 20R0-20R7. The second internal data transfer lines 21RO-21R7 are selectively coupled to the first internal data transfer lines 20R0-20R7 via switching elements SW0r-SW7r. Each of the switching elements SW0r-SW7r is turned into a non-conductive state when the shift instruction signal/SFTR is activated and a conductive state when the shift instruction signal/SFTR is deactivated, whereby the 0-bit shift operation is realized. A set of data transfer lines 20R0-20R7 and 21R0-21R7 correspond to the right-side internal data transfer lines 15R0-15R7 (reference number not shown in FIG. 5).

The shift data bus includes an upshift data bus 10UR and a downshift data bus 10RD. The upshift data bus 10UR includes a 1-entry upshift bus USR1, a 2-entry upshift bus USR2, and a 4-entry upshift data bus USR4. The downshift data bus 10DR includes a 1-entry downshift bus DSR1, a 2-entry downshift bus DSR2, and a 4-entry downshift data bus DSR4. Shift operation of the specified entry number is performed via these shift buses.

The upshifters USFR0-USFR7 are respectively provided for the first data transfer lines 20R0-20R7 and respectively include a 1-entry upshift driver 22ar, a 2-entry upshift driver 22br, and a 4-entry upshift driver 22cr. The 1-entry upshift driver 22ar is activated when the upshift instruction signal USR0 is activated, and performs data transfer to adjacent entries. The 2-entry upshift driver 22br is activated when the 2-entry upshift instruction signal USR2 is activated, and transfers the data on the first data transfer lines 20R0-20R7 of the corresponding entry to an entry separated by two entries (entry ERR0 for entry ERR2). The 4-entry upshift driver 22cr 4 is activated when the 4-entry upshift instruction signal USR4 is activated, and couples the corresponding first data transfer lines 20R0-20R7 to the second data transfer lines 21R0-21R7 of an entry at a position separated by four entries. In this manner, the first data transfer lines 20R0-20R7 are coupled to the second data transfer lines 21R0-21R7 at the time of the shift operation.

Each of the downshifters DSFR0-DSFR7 includes a 1-entry downshift driver 24ar, a 2-entry downshift driver 24br, and a 4-entry downshift driver 24cr. The 1-entry downshift driver 24ar is activated when the 1-entry downshift instruction signal DSR1 is activated, and couples the corresponding first data transfer line 20R0 to the second data transfer lines 21R1-21R7 and 21R0 of adjacent entries. The 2-entry downshift driver 24br is activated when the 2-entry downshift instruction signal DSR2 is activated, and couples the corresponding first data transfer line 20Ri to the second data transfer line 21R (i+2) at a position separated by two entries.

The 4-entry downshift driver 24cr is activated when the 4-entry downshift instruction signal SR4 is activated, and couples the corresponding first data transfer line 20Ri to the second data transfer line 15R (i+4) at a position separated by four entries. Here, i is 0 to 7, and (i+2) and (i+4) indicate modulo 7 operations.

The processing elements PE0-PE7 are respectively coupled to the first data transfer lines 20L0, 20R0-20L7 and 20R7, and the second data transfer lines 21L0, 21R0-21L7 and 21R7 to perform the specified arithmetic processing.

When shift operation is not performed as shown in FIGS. 4 and 5, the switching elements SW0-SW7 and SW0r-SW7r perform arithmetic processing on the data of a selected memory cell of corresponding left-side entries ERL0-ERL7 and corresponding right-side entries ERR0-ERR7, in the processing elements PE0-PE7, and store the result of processing in a specified bit position of the corresponding entry.

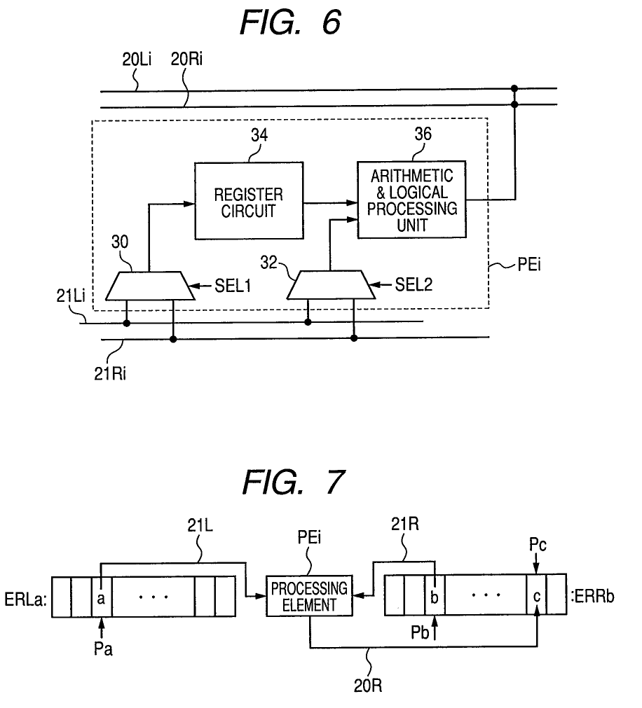

FIG. 6 illustrates an exemplary configuration of the processing element PE. In FIG. 6, the configuration of a processing element PEi is shown representatively. The processing elements PE0-PE7 (PEn) have an identical configuration.

In FIG. 6, the processing element PEi includes two selectors 30 and 32, a register circuit 34 which stores the output data of the selector 30, and an arithmetic & logical processing unit 36 which performs a predefined operation on the storage data of the register circuit 34 and the output data of the selector 32.

The selector 30 selects one of the data on the second data transfer lines 21Li and 21Ri according to the selection signal SEL1 and transfers it to the register circuit 34. The selector 32 selects one of the data of the second data transfer lines 21Li and 21Ri according to the selection signal SEL2 and provides it to the arithmetic & logical processing unit 36. The arithmetic & logical processing unit 36 includes a full adder for example, and can perform addition and subtraction. In the arithmetic & logical processing unit 36, it may be configured so that not only the full adder functionality but also other logical operation functions (NOT, AND, and OR operations) are realized using a part of the configuration of the full adder.

In FIG. 6, the output data of the arithmetic & logical processing unit 36 is shown, for example, in a manner that it is transferred to both the right-side and left-side first data transfer lines 20Li and 20Ri. However, the output data of the arithmetic & logical processing unit 36 may be selectively transferred to the second data transfer lines 21Li and 21Ri via a switch circuit. Also in the case of the above configuration, the processing result data can be stored in the memory cells of the specified entries by the switching elements SW0-SW7 and SW0r-SW7r shown in FIG. 4 and FIG. 5, respectively. Additionally, depending on the type of processing or application, it may be determined as appropriate whether the right or left data register circuit stores the result of processing. The memory cell is selected in the specified data register circuit of the right-side and left-side data register circuits and the result of processing is stored.

FIG. 7 schematically illustrates the processing mode of the processing element PE shown in FIG. 6. The processing element PEi performs a predefined arithmetic processing on the data stored in the entries ERLa and ERRb and stores the processing result in the entry ERRb. The entries ERLa and ERRb include a memory cell line and have a data storage area of a plurality of bits. The bit a specified by the pointer pa of the entry ERLa and the bit b specified by the pointer pb of the entry ERRb are transferred (loaded) to the processing element PEi. A predefined arithmetic processing is performed in the processing element PEi, and the processing result c is stored at a position specified by the pointer pc of the entry ERRb. In this processing mode, data are processed in a bit-serial mode. At the time of this processing, the processing is performed in a plurality of processing elements PE in parallel.

Using the parallel arithmetic device shown in FIGS. 1 to 7, a basic block is formed as a library. The parallel processing function is extended/reduced using the library.

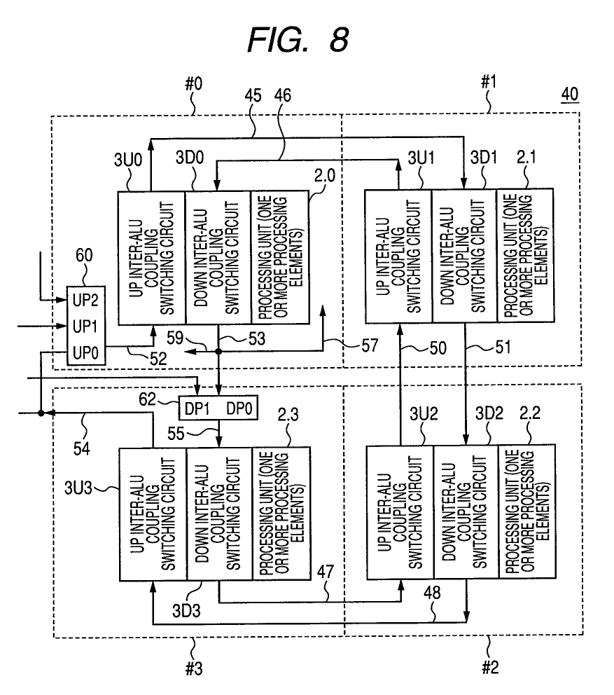

FIG. 8 schematically illustrates an exemplary configuration of a basic block 40 with a minimum dividable size of the parallel arithmetic device according to the embodiment 1 of the present invention. In FIG. 8, the basic block 40 includes four unit blocks #0-#3. In a large-scale basic block configuration, the basic block 40 is the minimum dividable basic block and it is the basic block having the minimum feasible block size.

Although each of the unit blocks #0-#3 has an configuration shown in FIG. 1, the configuration of an up inter-ALU coupling switching circuit, a down inter-ALU coupling switching circuit, and an processing unit (one or more processing elements) relating to the wire connection of the unit block are shown representatively in FIG. 8. In other words, the unit block #0 has an up inter-ALU coupling switching circuit 3U0, a down inter-ALU coupling switching circuit 3D0, and a processing unit (one or more processing elements) 2.0, and the unit block #1 has an up inter-ALU coupling switching circuit 3U1, a down inter-ALU coupling switching circuit 3D1, and a processing unit (one or more processing elements) 2.1. The unit block #2 has an up inter-ALU coupling switching circuit 3U2, a down inter-ALU coupling switching circuit 3D2, and a processing unit (one or more processing elements) 2.2, and the unit block #3 has an up inter-ALU coupling switching circuit 3U3, a down inter-ALU coupling switching circuit 3D3, and an processing unit (one or more processing elements) 2.3.

The downstream part of the up inter-ALU coupling switching circuit 3U0 of the unit block #0 is coupled to the upstream part of the down inter-ALU coupling switching circuit 3D1 of the unit block #1 via a wiring (bus) 45. Here, the upstream part and the downstream part indicate the shift start point and end point at the time of the shift operation in the coupling switching circuit.

Similarly, the upstream part of the down inter-ALU coupling switching circuit 3D0 of the unit block #0 is coupled to the downstream part of the up inter-ALU coupling switching circuit 3U1 of the unit block #1 via a wiring (bus) 46. The upstream part of the up inter-ALU coupling switching circuit 3U1 of the unit block #1 is coupled to the downstream part of the up inter-ALU coupling switching circuit 3U2 of the unit block #2 via wiring 50. In addition, the downstream part of the down inter-ALU coupling switching circuit 3D1 of the unit block #1 is coupled to the upstream part of the down inter-ALU coupling switching circuit 3D2 of the unit block #2 via a wiring (bus) 51.

The upstream part of the up inter-ALU coupling switching circuit 3U2 of the unit block #2 is coupled to the downstream part of the down inter-ALU coupling switching circuit 3D3 of unit block #3 via the wiring (bus) 47, and the downstream part of the down inter-ALU coupling switching circuit 3D2 of the unit block #2 is coupled to the upstream part of coupling switching circuit 3U3 up inter-ALU of unit block #3 via the wiring (a bus) 48.

In the unit block #0, a selector 60 is provided in the upstream part of the up inter-ALU coupling switching circuit 3U0, and a selector 62 is provided in the upstream part of the down inter-ALU coupling switching circuit 3D3 of the unit block #3. When extending the basic block size, the selectors 60 and 62 are provided in the data input part of the entire minimum dividable basic block 40. When a selector is provided in the up inter-ALU coupling switching circuit 3U0 of one of the unit blocks #0 and #3, a selector is provided in the down inter-ALU switching circuit 3U3 of the unit block #3. The regularity of the arrangement of the selector will be described in detail below.

The selector 60 includes three input ports UP0, UP1 and UP2, and the downstream part of the up inter-ALU coupling switching circuit 3U3 of the unit block #3 is coupled to the port UP0 of the selector 60 via the wiring 54. The ports UP2 and UP1 are provided to be coupled to the output wiring of adjacent unit blocks when the basic block 40 is extended. The output wiring 52 is coupled to the selector 60 at the downstream part of the up inter-ALU coupling switching circuit 3U0 of the unit block #0.

The selector 62 includes ports DP0 and DP1, and the port DP0 is coupled to the downstream part of the down inter-ALU coupling switching circuit 3D0 of the unit block #0 via the wiring 53. The wiring 53 is also coupled to branch wirings 57 and 59. The branch wirings 57 and 59 are coupled at the time of extension to an input selector of the unit block adjacently or oppositely arranged. The port DP1 is coupled to the output wiring of an adjacent unit block not shown. The output part of the selector 62 is coupled to the upstream part of the down inter-ALU coupling switching circuit 3D3 of the unit block #3 via the wiring 55.

In the basic block 40, a coupling path can be formed in a loop within these up inter-ALU coupling switching circuits 3U0-3U3 and down inter-ALU coupling switching circuits 3D0-3D3 using the wirings 45, 46, 47, 48, 42, 53, 54 and 55, and coupling to a basic block having an identical configuration as with the basic block 40 can be formed while preserving the data transfer direction. In this manner, data can be transferred to distant processing elements beyond respective unit blocks #0-#3. In addition, the size of the basic block of the parallel arithmetic device can be changed by switching the coupling path of the selectors 60 and 62.

Here, in the basic block 40 shown in FIG. 8, the arrangement of the bus interface of the unit blocks #0-#3 and the internal data bus is not shown. It suffices to appropriately define the coupling mode of the internal buses of these bus interface parts according to the arrangement of the global data bus provided for the basic block 40. Therefore, the bus interface of the unit blocks #0-#3 may be coupled in parallel to the global data bus or, similarly with the processing element, the bus interfaces may be alternately coupled to the internal data bus in a loop via the bus interfaces and the internal data bus.

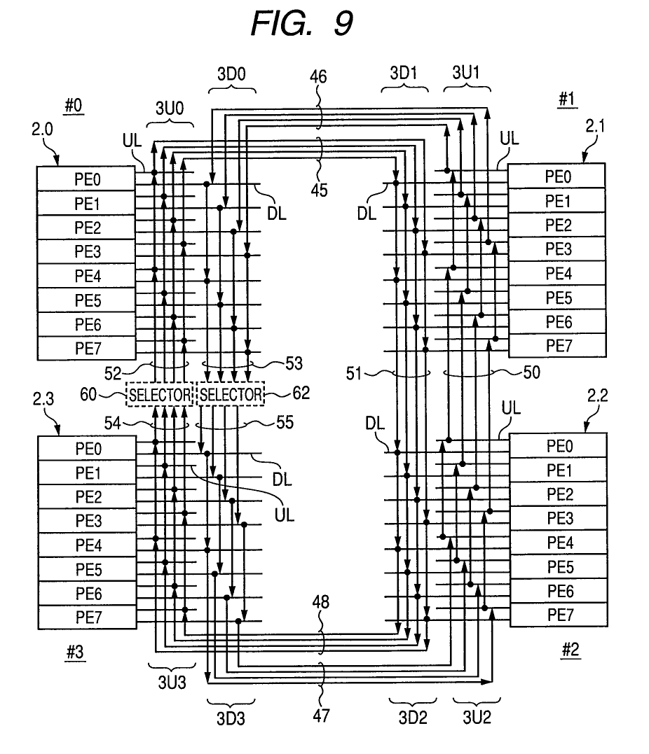

FIG. 9 schematically illustrates an exemplary arrangement of wirings 45-48 and 52-55 of the basic block 40 shown in FIG. 8. In FIG. 9, an arrangement of the wirings is shown as an example in which the processing units (one or more processing elements) 2.0-2.3 of the unit blocks #0-#3 respectively have eight processing elements PE0-PE7. In order to avoid complication of the drawing, a wire connection of the part that performs 4-entry shift is representatively shown as the wirings 45-48 and 50-55.

In FIG. 9, the wiring 45 joins the upshift transfer line UL for the processing elements PE0-PE3 in the up inter-ALU coupling switching circuit 3U0 of the unit block #0 to the downshift transfer line DL provided for the processing elements PE0-PE3 of the down inter-ALU coupling switching circuit 3D1 of the unit block #1. The upshift transfer line UL indicates the first data transfer lines (20R and 20L) and the second data transfer lines (21L and 21R) provided for the processing element PE, and the upshift driver which is provided in correspondence. The upshift driver is indicated by the “” mark. The destination of the transfer is indicated by the arrow of the wiring.

The wiring 46 couples the upshift transfer line UL provided for the processing elements PE0-PE3 of the unit block #1 to the downshift transfer line DL provided for the processing elements PE0-PE3 of the down inter-ALU coupling switching circuit 3D0 of the unit block #0. Here, the downshift transfer line DL includes, similarly with the upshift transfer line UL, second internal data transfer lines 21L and 21R, first data transfer lines 20L and 20R, and a downshift driver provided in correspondence.

The wiring 48 couples the downshift line DL provided for the processing elements PE4-PE7 of the unit block #2 to the upshift line UL to be provided for the processing elements PE4-PE7 of the up inter-ALU coupling switching circuit 3U3 of the unit block #3. The wiring 49 couples the downshift transfer line DL provided for the processing elements PE4-PE7 of the down inter-ALU coupling switching circuit 3D3 of the unit block #3 to the upshift transfer UL provided for the processing elements PE4-PE7 of the up inter-ALU coupling switching circuit 3U2 of the unit block #2. The wiring 47 couples the downshift transfer line DL provided for the processing elements PE4-PE7 of the down inter-ALU coupling switching circuit 3D3 of the unit block #3 to the upshift transfer line UL provided for the processing elements PE4-PE7 of the up inter-ALU coupling switching circuit 3U2 of the unit block #2.

The wiring 50 couples the upshift transfer line UL provided for the processing elements PE0-PE3 of the up inter-ALU coupling switching circuit 3U2 of the unit block #2 to the upshift transfer line UL provided for the processing elements PE4-PE7 of the unit block #1, respectively. The wiring 51 couples the downshift transfer line DL provided for the processing elements PE4-PE7 of the down inter-ALU coupling switching circuit 3D1 of the unit block #1 to the downshift transfer line DL provided for the processing elements PE0-PE3 of the down inter-ALU coupling switching circuit 3D2 of the unit block #2.

The wiring 52 couples a wiring selected by the selector 60 to the upshift transfer line UL provided for the processing elements PE4-PE7 of the up inter-ALU coupling switching circuit 3U0 of the unit block #0. The wiring 53 couples, to the selector 62, the downshift transfer line DL provided for the processing elements PE4-PE7 of the down inter-ALU coupling switching circuit 3D0 of the unit block #0.

The wiring 54 couples the upshift transfer line UL provided for the processing elements PE0-PE3 of the unit block #3 to a port (UP0) of the selector 60. The wiring 55 couples a selected wiring of the selector 62 to the downshift transfer line DL provided for the processing elements P0E-PE3 of the down inter-ALU coupling switching circuit 3D3 of the unit block #3.

With regard to these wirings 45-48 and 50-55, the wirings are respectively provided according to the number of shift entries and their bit widths are set.

When the shift path is extended in a ring shape, instead of simply turning back the coupling path inward in the case of shifting up/down in a cyclic manner within a single unit block, it is extended outside of the unit block. This is realized by simply switching the wire connection (path setting by mask wiring).

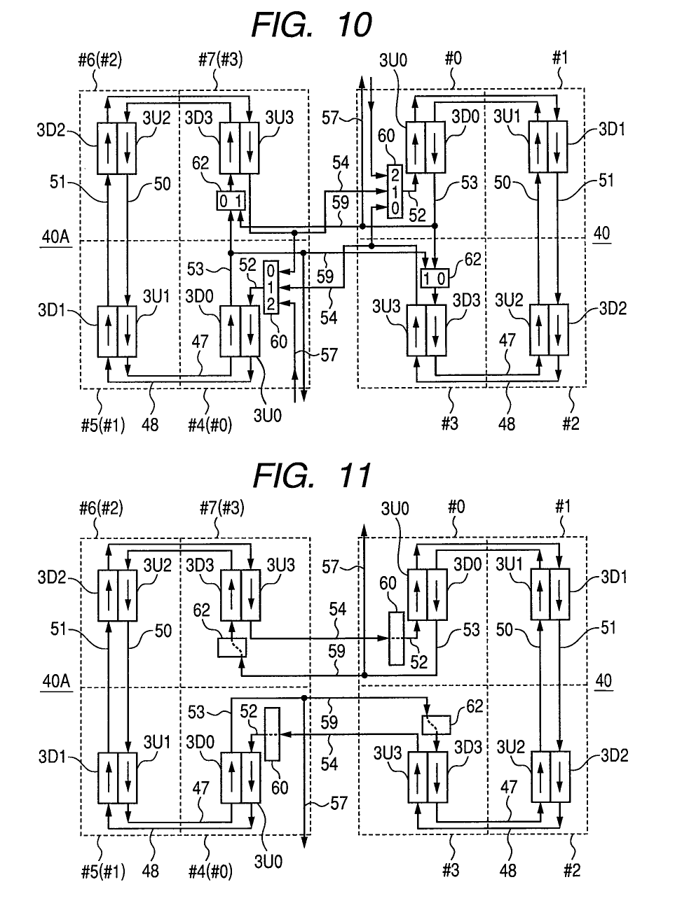

FIG. 10 illustrates, using the basic block 40 shown in FIG. 8, an exemplary configuration when the basic block includes eight unit blocks. In FIG. 10, 180-degree rotation is performed on the basic block 40 to form a second basic block 40A. Since the unit blocks #0-#3 in the basic block 40 are rotated by 180 degrees via this manipulation, the unit blocks #0-#3 respectively correspond to new unit blocks #4-#7 in the second basic block 40A. The correspondence relationship of unit blocks is shown in FIG. 10 such that for each of the unit blocks #4-#7 the corresponding unit block is indicated in the parenthesis.

A selector 60 is provided in the unit block #0 and a selector 62 is provided in the unit block #3. A selector 62 is provided in the unit block #7 and a selector 60 is provided in the unit block #4.

The port 1 (UP1) of the selector 60 of the unit block #0 is coupled to the wiring 54 at the downstream of the inter-ALU coupling switching circuit 3U3 of the unit block #7. A wiring 59 branching from the wiring 53 at the downstream of the inter-ALU coupling switching circuit 3D0 of the unit block #0 is coupled to the port 1 (DP1) of the selector 62 of the unit block #7. A wiring 59 branching from the wiring 53 at the downstream of the inter-ALU coupling switching circuit 3D0 of the unit block #4 is coupled to the port 1 (DP1) of the selector 62 of the unit block #3. The wiring 54 of the upstream part of the inter-ALU coupling switching circuit 3U3 of the unit block #3 is coupled to the port 1 (UP1) of the selector 60 of the unit block #4.

With the basic block 40A formed by rotating the basic block 40, the shift directions of the unit blocks #4-#7 in the inter-ALU coupling switching circuit are just opposite at the basic block 40 and the basic block 40A. A state is set to select the port 1 (UP1) of the selector 60 included in the unit blocks #0 and #4, and the selector 62 included in the unit blocks #3 and #7 is set to a state for selecting the port 1 (DP1). Setting of the coupling path of the selectors 62 and 60 is performed according to the number of unit blocks included in the basic block (e.g., by mask wiring).

In the basic blocks 40 and 40A including eight unit blocks shown in FIG. 10, the selectors 60 and 62 are provided at the data input part of the unit block, and the data output part of the unit block is coupled via the wiring to the input part of the selector of adjacent unit blocks and oppositely arranged unit blocks. In the oppositely arranged unit blocks, the selectors are provided for the input part of the up inter-ALU coupling switching circuit (upstream part) in one of the unit blocks, whereas the selector are provided for the data input part of the down inter-ALU coupling switching circuit (upstream part) in the other unit block. By the above arrangement of the selectors 60 and 62, the number of unit blocks of the basic block constituting the parallel arithmetic device can be changed by simply switching the coupling path in the 4-unit-block configuration and the 8-unit-block configuration.

FIG. 11 schematically illustrates the data transfer path of the arrangement shown in FIG. 10. As shown in FIG. 11, the selector 60 of the unit block #0 selects the output data from the downstream side of the inter-ALU coupling switching circuit 3U3 of the unit block #7, and couples it to the upstream part of the inter-ALU coupling switching circuit 3U0 of the unit block #0. The selector 62 of the unit block #3 selects the output data of the down inter-ALU coupling switching circuit 3D0 of the unit block #4, and transmits it to the upstream part of the down inter-ALU coupling switching circuit 3D3 of the unit block #3.

The selector 62 of the unit block #7 selects the output data of the inter-ALU coupling switching circuit 3D0 of the unit block #0, and transmits it to the upstream part of the down inter-ALU coupling switching circuit 3D3 of the unit block #7. The selector 60 of the unit block #4 selects the output data from the downstream side of the up inter-ALU coupling switching circuit 3U3 of the unit block #3, and transmits it to the upstream side of the up inter-ALU coupling switching circuit 3U1 of the unit block #4. With such a coupling path, a torus-like data transmission path is formed for both upshift and downshift.

As shown in FIG. 11, the basic block is provided so that the first and the last of the serial numbers of a single minimum basic block are respectively adjacent to the last and the first numbers of the serial numbers of the expanded basic block. In this manner, only a wiring for transferring data between adjacent unit blocks is required in a large-scale basic block whereby the wiring layout area can be reduced, and additionally the wiring distance is shortened whereby propagation delay of signal data can be reduced. In addition, because it suffices to only change the coupling path of the selector in order to change the size of the basic block, and it suffices to only set the logic level of the path setting signal of the selector by mask wiring, for example, according to the size of the basic block in order to set the path of the selector, no control circuit is required to change the path.

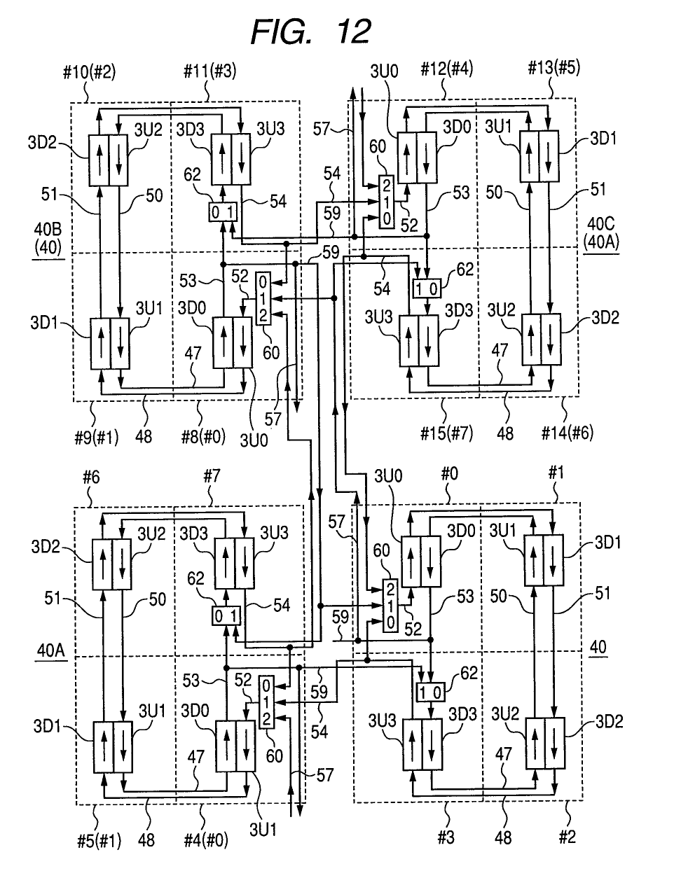

FIG. 12 schematically illustrates the configuration when the basic block includes 16 unit blocks using the minimum dividable basic block 40 shown in FIG. 8. In FIG. 12, with the unit blocks #0-#7 as one starting basic block, a 180-degree rotation is performed on the starting basic block to form new basic blocks 40B and 40C. The new basic blocks 40B and 40C correspond to a block after rotating the basic blocks 40 and 40A of the original starting basic block.

The above rotation results in an arrangement of 16 unit blocks #0-#15. In this case, the last block number #15 and the first block number #8 of the newly expanded basic block are arranged adjacent to the first block number #0 and the last block number #7 of the unit blocks of the starting basic block. Serial numbers are provided to unit blocks of the minimum dividable basic block.

In the above arrangement, the wiring 54 in the downstream side of the inter-ALU coupling switching circuit 3U3 of the unit block #7 of the basic block 40A is also coupled to the port 2 (DP2) of the selector 60 of the unit block #8. The wiring 53 at the downstream of the inter-ALU coupling switching circuit 3D0 of this unit block #8 is coupled to the port 1 (DP1) of the selector 62 of the unit block #7 again. The wiring 53 in the downstream of the inter-ALU coupling switching circuit 3D0 of the unit block #8 is also coupled to the port 1 (DP1) of the selector 60 of the unit block #0.

The part coupled to the port 2 (DP2) of the selector 60 of the unit block #0 is coupled to the wiring 54 at the downstream of the inter-ALU coupling switching circuit 3U3 of the unit block #15. The other coupling modes of these unit blocks #0-#7 are identical to the coupling mode previously shown in FIG. 10, and the remaining wirings of the unit blocks #8-#15 are also identical (symmetric) to the wire connection modes of the unit blocks #0-#7. Identical reference numerals are assigned to the wirings corresponding to those shown in FIG. 10, and detailed description thereof is omitted.

Since rotation operation is performed, in the configuration shown in FIG. 12, the shift direction of the up inter-ALU coupling switching circuit 3U is directed downward in the figure, whereas the shift direction of the down inter-ALU coupling switching circuit 3D is directed upward, in the unit blocks #4 to #11. Regularity of the arrangement of the selectors 60 and 62 is identical to the configuration previously shown in FIG. 10, and a selector is provided at the data input part in the minimum dividable basic block (basic block including four unit blocks) to couple the data output wiring to the selectors of adjacent and opposing unit blocks. In addition, different selectors (60, 62) are provided between adjacent and opposing unit blocks.

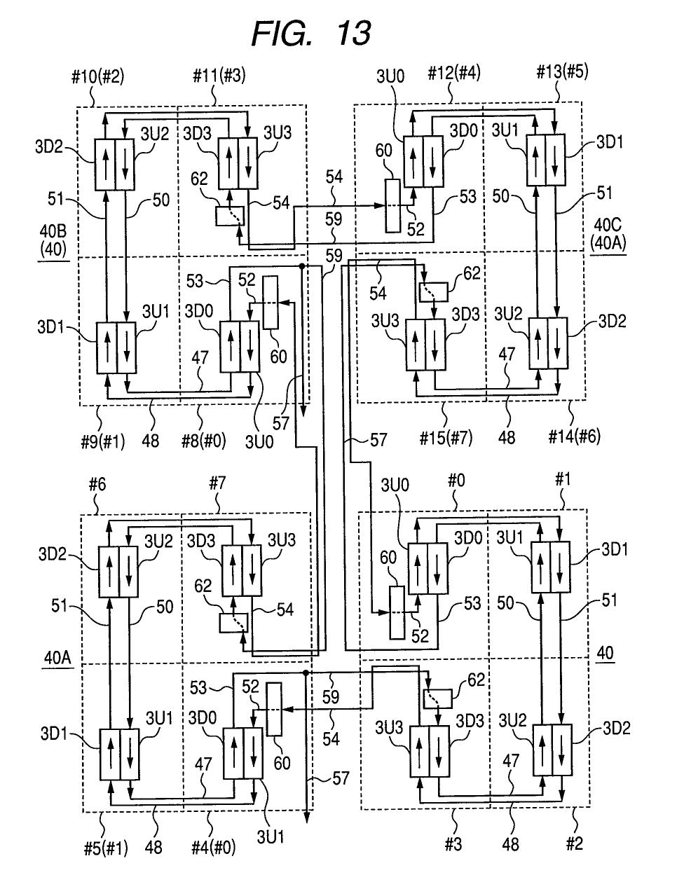

FIG. 13 schematically illustrates a data propagation path in a 16-unit-block configuration of the processing block (parallel arithmetic device) shown in FIG. 12. In FIG. 13, the selector 60 of the unit block #4 selects the output data of the inter-ALU coupling switching circuit 3U3 of the unit block #3 and transfers it to the upstream part of the inter-ALU coupling switching circuit 3U1 of the unit block #4. The selector 62 of the unit block #7 receives, via the wiring 53, the output data of the inter-ALU coupling switching circuit 3D0 of the unit block #8 and transfers it to the upstream part of the inter-ALU coupling switching circuit 3D3 of the unit block #7.

The selector 60 of the unit block #8 selects the output data of the inter-ALU coupling switching circuit 3U3 of the unit block #7 and transmits it to the upstream part of the inter-ALU coupling switching circuit 3U0 of the unit block #8. The selector 62 of the unit block #11 selects the output data of the inter-ALU coupling switching circuit 3E0 of the unit block #12 and transfers it to the upstream part of the inter-ALU coupling switching circuit 3D3 of the unit block #11.

The selector 60 of the unit block #12 couples the output wiring 54 of the inter-ALU coupling switching circuit 3U3 of the unit block #11 to the upstream part of the inter-ALU coupling switching circuit 3U0 of the unit block #12. The selector 62 of the unit block #15 receives, via the wirings 53 and 57, the output data of the inter-ALU coupling switching circuit 3D0 of the unit block #0 and transfers it to the upstream part of the inter-ALU coupling switching circuit 3D3 of the unit block #15.

In the configuration shown in FIG. 13, a closed loop data transfer path is formed by the block numbers serially assigned to the 16 unit blocks #0-#15. By setting the coupling path of the selectors 60 and 62 according to the size of the basic block, the processing block can be divided into two basic blocks (a basic block including the basic blocks 40 and 40A, and a basic block including basic blocks 40C and 40D) each having eight unit blocks, and four basic blocks (basic blocks 40, 40A, 40B, 40C and 40D) each having four unit blocks. In these unit blocks #0-#15, a data transfer path is formed only between adjacent unit blocks, whereby data transfer can be performed at a high speed without wiring delay.

In addition, data transfer can be performed beyond unit blocks, and data transfer can be realized even between any number of entries.

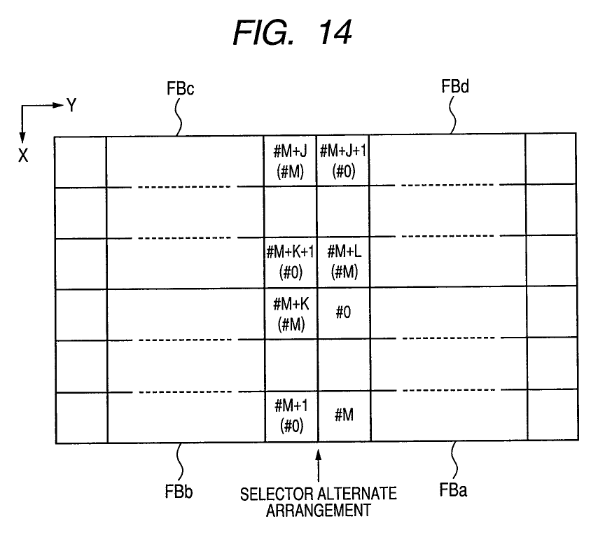

FIG. 14 schematically illustrates an operation which realizes a configuration capable of extending/reducing the block size of the parallel arithmetic device according to the embodiment 1 of the present invention. In FIG. 14, four starting basic blocks FBa-FBd are provided. The starting basic block FBa has unit blocks #0-#M. In the starting basic block FBa, selectors are provided so that a data transfer path can be formed in a loop in the unit blocks #0-#M (selectors 60 and 62 are alternately arranged at the input part of the unit block in the boundary region of the minimum dividable basic block (different selectors 60 and 62 are provided in adjacent unit blocks and opposing unit blocks)).

The starting basic block FBb is formed by rotation using the starting basic block FBa. In this case, the last block number #M+K (=#M+M+1) and the first block number #M+1 of the starting basic block FBb are arranged adjacent to the first block number #0 and the last block number #M of a unit block of the starting basic block FBa, respectively. The unit blocks #M+1 and #M+K of the starting basic block FBb respectively correspond to the unit blocks #0 and #M of the starting basic block FBa.

If, in the starting basic block FBa, a selector is provided so that coupling of respective unit blocks is provided only between adjacent unit blocks and also a loop is formed, a coupling path in the starting basic blocks FBa and FBb can be formed in a closed loop manner by changing the wiring path in the boundary region of the basic blocks FBa and FBb using the selectors.

The starting basic blocks FBc and FBd are respectively formed using the starting basic blocks FBa and FBb. In this case, the starting basic blocks FBc and FBd are arranged by rotating the starting basic blocks FBa and FBb. By this rotation, the first unit block #M+K+1 of the starting basic block FBc is arranged adjacent to the last unit block #M+K of the starting basic block FBb. In this case, the unit blocks #M+K+1 and #M+J in the basic block FBc are arranged rotationally symmetric to the unit blocks #0 and #M, respectively.

A unit block #M+L (=#M+J+M+1) of the starting basic block FBd having its last number is arranged adjacent to the first unit block #0 of the starting basic block FBa. The unit blocks #M+J+1 and #M+1 in the starting basic block FBd correspond to the unit block #M and the unit block #0, respectively. Therefore, also in this case, since a wiring is provided in the basic blocks FBa and FBb to connect adjacent unit blocks in a loop, a wiring can be provided to connect continuously between adjacent unit blocks in a loop-like manner in the basic blocks FBc and FBd as well.

In these basic blocks FBa-FBd, selectors 60 and 62 for selecting a data transfer path are alternately arranged in the boundary region in the Y-direction. Therefore, in the basic blocks FBc and FBb, it is possible to couple the data/signal propagation path in the unit blocks #M+K+1 and #M+K, and also couple the data transfer path of the unit block #M+L of the basic clock FBd and the unit block #0 of the basic block FBa, using the selectors. By these coupling paths, a torus-like closed wiring path can be formed so as to provide a coupling between adjacent unit blocks in the basic blocks FBa-FBd as a whole.

According to the order of extension shown in FIG. 14, the block size can be changed by simply switching the wiring path from a basic block having a large size to the minimum dividable basic block.

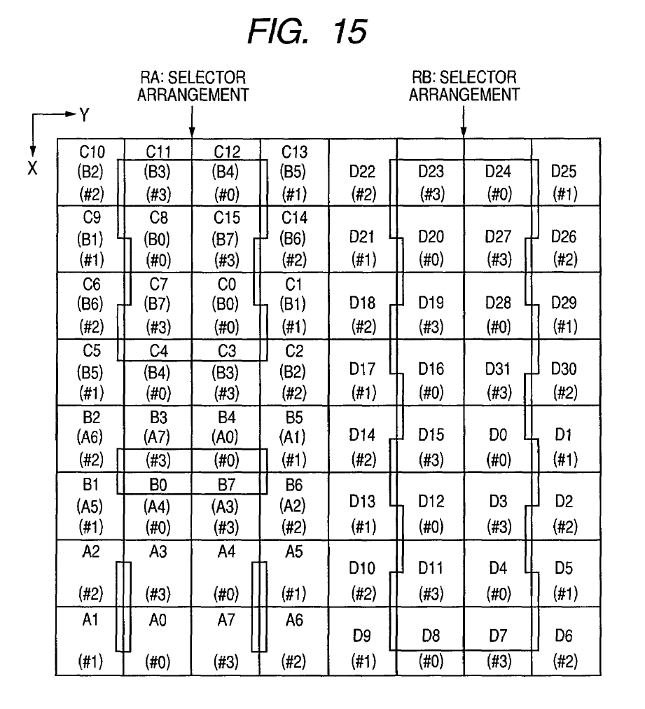

FIG. 15 illustrates an exemplary arrangement of a unit block of the parallel arithmetic device and a configuration of a wire connection in the embodiment 1 of the present invention. In FIG. 15, a case is shown as an example in which 16 basic blocks including four unit blocks #0-#3 are arranged in the parallel arithmetic device. When the block size is extended, a starting basic block is provided and sequentially arranged by rotation as described above, based on the arrangement of the minimum dividable basic block including four unit blocks.

In an array of unit blocks aligned in the X-direction, the unit block array in which unit blocks #1 and unit blocks #2 are alternately aligned, and the unit block array in which unit blocks #0 and #3 are alternately arranged are alternately arranged in the Y-direction. The array of unit blocks #1 and #2 are always coupled, and wire connection is possible in the unit blocks #0 and #3 for extension.

Selectors (60, 62) are alternately arranged for each of the unit blocks #0 and #3 in the X-direction in the boundary regions RA and RB of the minimum dividable unit block in the Y-direction. Selectors are not arranged in the inter-unit-block region between the regions RA and RB in the Y-direction.

In the arrangement of unit blocks shown in FIG. 15, a basic block including four minimum-size unit blocks #0-#3 is provided by unit blocks A0-A3 and A4-A7. Of these unit blocks A0-A7, the unit blocks A3 and A4 can be coupled using an unshown selector, and also a basic block including eight unit blocks B0-B7 can be realized by coupling the unit blocks A0 and A7.

By arranging these basic blocks B0-B7 via rotation and coupling the data transfer path of opposing and adjacent unit blocks #0 and #3 using a selector, a basic block including 16 unit blocks C0-C15 can be realized. In FIG. 15, a unit block corresponding to each extended basic block and its preceding starting basic block are shown in the parenthesis.

Conversely speaking, it is shown that a basic block including 16 unit blocks C0-C15 can be realized with a basic block including eight unit blocks by switching the coupling of data transfer paths, and that a basic block including eight unit blocks can be divided into a basic block including four unit blocks. As for the numbering of unit blocks, since the position of the starting unit block is arbitrary, the numbering of unit blocks is assigned so that the block numbers are serial in any of the basic blocks including 4, 8 or 16 unit blocks.

Also in this case, extension and reduction of basic blocks can be easily realized by arranging so that the first and the last block numbers of a series of the serial block numbers of respective starting basic blocks are adjacent to the last block number and the first block number of the additional basic block, respectively.

By further arranging the 16 basic blocks C0-C15 via rotation thereof, a basic block including 32 unit blocks D0-D31 can be realized. In these unit blocks D0-D31, unit block numbers D0-D31 are assigned so that the first and the last block numbers of the next basic block of a smaller block size, i.e., the basic block having 16 unit blocks are adjacent to the last block number and the first block number of the block numbers of the additional 16 unit blocks. In FIG. 15, block numbers of the minimum initial starting unit blocks #0-#3 are shown together in the parentheses.

For a basic block of any block size, block numbers are assigned so that the first and the last block numbers of the first basic block of two adjacent basic blocks are respectively adjacent to the last and the first block numbers of the second basic block. For the minimum dividable basic block, extended coupling of unit blocks is possible in the unit blocks #0 and #3. Therefore, a basic block including 32, 16, 8 or 4 unit blocks can be realized by unit blocks including 8 rows in the X-direction and 4 columns in the Y-direction.

As thus described, according to the configuration shown in the embodiment 1 of the present invention, a basic block including 32 unit blocks can be divided into basic blocks including 16, 8 and 4 unit blocks, respectively. By extending these 32 basic blocks in the X-direction via further rotation, a basic block including 64 basic unit blocks can be realized (block numbers are assigned so that the first and the last block numbers are adjacent in the boundary region of the 32 unit blocks, in the 64-unit block configuration).

Therefore, reduction to a basic block of a smaller block size can be realized by preparing a parallel arithmetic device including a large number of basic blocks and arranging respective unit blocks so that they can be wire-connected in a torus. In addition, processings can be performed in parallel by changing the block size of the basic block or operating a plurality of basic blocks in parallel, according to the type of processing.

### Exemplary Variation

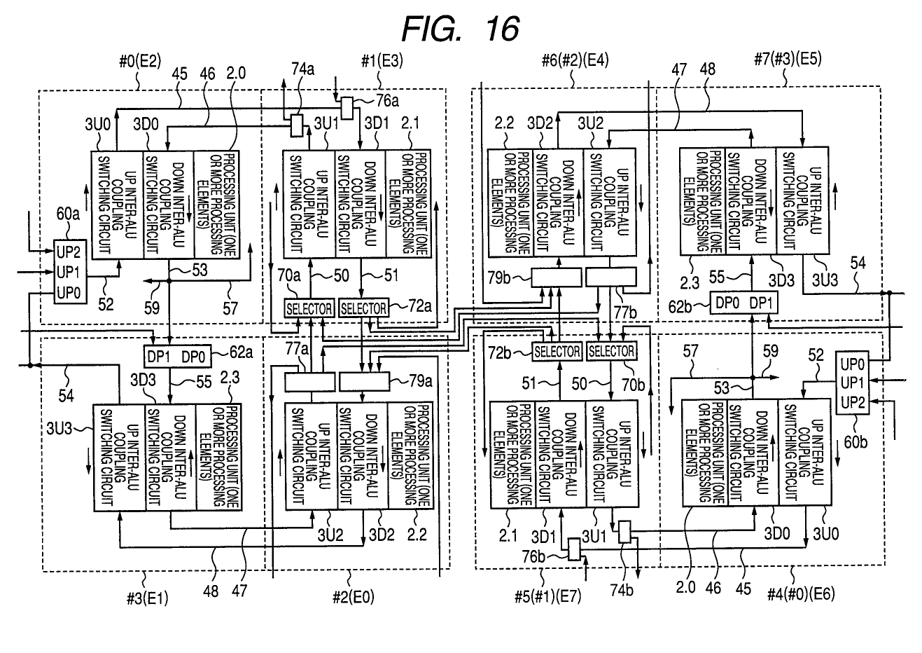

FIG. 16 schematically illustrates the configuration of a variation of the parallel arithmetic device of the embodiment 1 of the present invention. In FIG. 16, rotation is performed on the basic block (minimum dividable basic block) including unit blocks #0-#3 to provide a basic block including new unit blocks #4-#7.

The configuration of the unit blocks #0-#3 is different from that shown in FIG. 8 in the following points. Specifically, in the unit block #1, a selector 74a is provided in the downstream part of the up inter-ALU coupling switching circuit 3U1, and a selector 76a is provided in the upstream part of the down inter-ALU coupling switching circuit 3D1. The selector 74a selects one of: the wiring 46 for the down inter-ALU coupling switching circuit 3D0 of the unit block #0; or a wiring from the down inter-ALU coupling switching circuit of an unshown unit block arranged adjacent to the unit block #1 at the upper part of the figure, and couples it to the up inter-ALU coupling switching circuit 3U1 of the unit block #1.

Here, it is not particularly required to dispose selectors at both ends of the wiring of the data transmission path switching. It suffices that a coupling path of the wiring is selected by a selector on one side. Therefore, it is not particularly required to dispose a selector for respective inter-ALU coupling switching circuits to select an output path. However, FIG. 16 illustrates that selectors are arranged for respective inter-ALU coupling switching circuits in order to explicitly indicate the switching of data transmission paths.

The selector 76a selectively couples the upstream part of the down inter-ALU coupling switching circuit 3D1 of the unit block #1 to either one of a wiring from the down inter-ALU coupling switching circuit of the unit block (#2) arranged adjacent to the unshown upper part, or a data transfer path for the up inter-ALU coupling switching circuit 3U0 of the unit block #0.

Selectors 70a and 77a are arranged in a tandem manner between the up inter-ALU coupling switching circuits 3U1 and 3U2 of the unit blocks #1 and #2, and selectors 72a and 79a are arranged in a tandem coupling manner between the down inter-ALU coupling switching circuits 3D1 and 3D2. The selector 77a transmits the data from the downstream part of the up inter-ALU coupling switching circuit 3U2 of the unit block #2 to the down inter-ALU coupling switching circuit 3D1 of the unit block #5 (corresponding to the unit block #1) adjacently arranged so as to be opposite to the selector 70a and the unit block #2.

The selector 70a selects one of: the data selected by the selector 77a; a data transmission path selected by the selector 77b of the unit block #6 adjacently and oppositely arranged; and an output data transmission path of the unit block (corresponding to #2) adjacent to the upper part of the figure at the time of extension, and transmits it to the up inter-ALU coupling switching circuit 3U1 of the unit block #1.

The selector 72a transmits the data from the downstream side of the down inter-ALU coupling switching circuit 3D1 in the unit block #1 to one of the inputs of the selector 79a and the selector 79b included in the unit block #6.

The selector 77a transfers the data from the downstream side of the up inter-ALU coupling switching circuit 3U2 of the unit block #2 to any one of the selector 70a of the adjacently arranged unit block #1, the selector 70b of the oppositely arranged unit block #5, and a unit block adjacently arranged at the unshown lower part of the figure.

The selector 79a selects one of: the output data of the selector 72a; the output data of the up inter-ALU coupling switching circuit of a unit block (#1) arranged adjacent to the unit block #2 in the downward direction of the figure at the time of extension; and the data from the corresponding down inter-ALU coupling switching circuit 3D1 selected by the selector 72b of the adjacently and oppositely arranged unit block #5, and transmits it to the upstream part of the down inter-ALU coupling switching circuit 3D2 of the unit block #2.

Since the configuration of the unit blocks #0-#3 shown in FIG. 16 is identical to that of the basic blocks shown in FIG. 8, identical reference numerals are assigned to corresponding parts, and detailed description thereof is omitted.

In addition, the unit blocks #4-#7 are arranged by performing rotation on the unit blocks #0-#3, and the selectors 70b, 72b, 74b, 76b, 77b and 79b are arranged corresponding to the selectors 70a, 72a, 74a, 76a, 77a and 79a. For these unit blocks #4-#7, identical reference numerals are assigned to the parts corresponding to the unit blocks #0-#3, and detailed description thereof is omitted.

Also in the configuration shown in FIG. 16, the regularity is preserved with regard to the arrangement of the selectors such that the selectors are alternately arranged at the input path of the unit blocks in the boundary region of the minimum dividable basic block (minimum size basic block), and the output path of the unit blocks is coupled to the selector of adjacent unit blocks and oppositely arranged unit blocks. Therefore, the selectors 72 (72a, 72b) and 77 (77a, 77b) need not be provided in particular. The coupling path is established by selecting the selector at the input side. As previously described, it is shown in FIG. 16 that the selectors are arranged for respective inter-ALU coupling switching circuits to clearly define the coupling path.

Since the selectors 74a, 76a, 74b and 76b are provided to simply enhance the degree of freedom of coupling unit blocks, the selectors 74 and 76 need not be provided in particular.

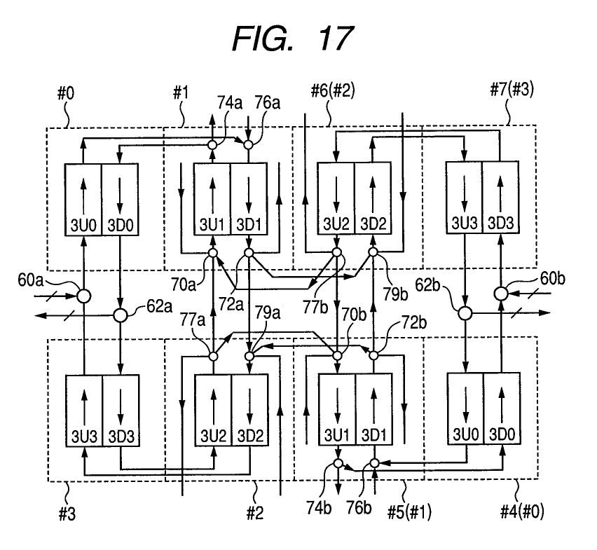

FIG. 17 illustrates a magnified view of the wire connection of the parallel arithmetic device shown in FIG. 16. In the unit blocks #0-#7, the processing units (one or more processing elements) 2.0-2.3 are not shown. Block numbers E0-E7 are provided for the unit blocks #0-#7 to indicate the coupling path in the case of 8-unit-block configuration. The block numbers E0-E7 are assigned so that the first and the last numbers of the unit blocks of the minimum dividable basic block are serial.

In the unit blocks #4-#7, since the arrangement of the unit blocks #0-#3 has been rotated, the unit blocks #0-#3 and the unit blocks #4-#7 have opposite shift directions with regard to the up inter-ALU coupling switching circuits 3U0-3U3 and the shift direction of the down inter-ALU coupling switching circuits 3D0-3D3.

The selector 70a selects one of selection output of the selector 77a; output of the selector 77b; and data transferred from the outside, and transfers it to the upstream part of the up inter-ALU coupling switching circuit 3U1 of the unit block #1. The selector 72a transfers the output data of the down inter-ALU coupling switching circuit 3D1 of the unit block #1 to any one of the selectors 79a, 79b, and a unit block adjacently arranged in the upper part of the figure.

The selector 77a transfers the data from the downstream side of the up inter-ALU coupling switching circuit 3U2 of the unit block #2 to any one of the selectors 70a, 70b, or a unit block arranged at the time of extension adjacent to the unit block #2 in the lower part of a figure.

The selector 79a selects any one of: the data provided from the down inter-ALU coupling switching circuit 3D1 via the selector 72a; the data transmitted from the down inter-ALU coupling switching circuit 3D1 via the selector 72b of the unit block #5; and the data transferred from a unit block arranged at the time of extension adjacent to the unit block #D2, and transmits it to the down inter-ALU coupling switching circuit 3D2 of the unit block #2.

The selector 74a transfers the output data of the up inter-ALU coupling switching circuit 3U1 of the unit block #1 to either the down inter-ALU coupling switching circuit 3D0 of the unit block #0 or a unit block arranged at the time of extension adjacently in the upper part of the unit block #1. The selector 76a selects either the output data of the up inter-ALU coupling switching circuit 3U0 of the unit block #0, or the output data of a unit block arranged at the time of extension adjacently in the upper part of the unit block #1, and transmits it to the upstream part of the down inter-ALU coupling switching circuit 3D1 of the unit block #1.

The selector 70b selects any one of the output data of a unit block arranged at the time of extension adjacent to the unit block #5 in the lower part of the figure, the output data of the up inter-ALU coupling switching circuit 3U2 of the unit block #2 provided via the selector 77a of the unit block #2; and the output data of the up inter-ALU coupling switching circuit 3U2 of the unit block #6 provided via the selector 77b, and transmits it to the up inter-ALU coupling switching circuit 3U1 of the unit block #5.

The selector 77b transfers the data from the downstream side of the up inter-ALU coupling switching circuit 3U2 of the unit block #6 to any one of the upstream parts of the up inter-ALU coupling switching circuits 3U1 of the unit blocks #1 and #5; and the data input part of a unit block arranged at the time of extension adjacent to the unit block #6 in the upper part of the figure.

The selector 79b selects one of: the output data of the down inter-ALU coupling switching circuit 3D1 provided via the selector 72a of the unit block #1; the output data of the down inter-ALU coupling switching circuit 3D1 of the unit block #5 provided via the selector 72b; and the output data from a unit block arranged at the time of extension adjacent to the upper part of the unit block #6, and transmits it to the down inter-ALU coupling switching circuit 3D2 of the unit block #6.

The selector 74b transfers the output data of the up inter-ALU coupling switching circuit 3U1 of the unit block #5 to either the down inter-ALU coupling switching circuit 3D0 of the unit block #4, or a unit block arranged at the time of extension adjacent to the lower part of the unit block #5. The selector 76b selects one of: the output data of the up inter-ALU coupling switching circuit 3U0 of the unit block #4; or the output data of a unit block arranged at the time of extension adjacent to the unit block #5, and transmits it to the down inter-ALU coupling switching circuits 3D1.

As shown in FIGS. 16 and 17, it is possible to change the data transfer path and extend or reduce the basic block size more flexibly, by providing a configuration that switches the data transfer path of the inter-ALU coupling switching circuits 3U1, 3D1, 3U2 and 3D2 also in the unit blocks #1 and #2 of the minimum basic block.

As can be clearly seen in FIG. 17, it is possible to delete the selectors 77 and 79 for setting an output path. In FIG. 17, the selectors 77a/b and 79a/b for selecting an output path are shown in order to explicitly indicate the data transfer path.

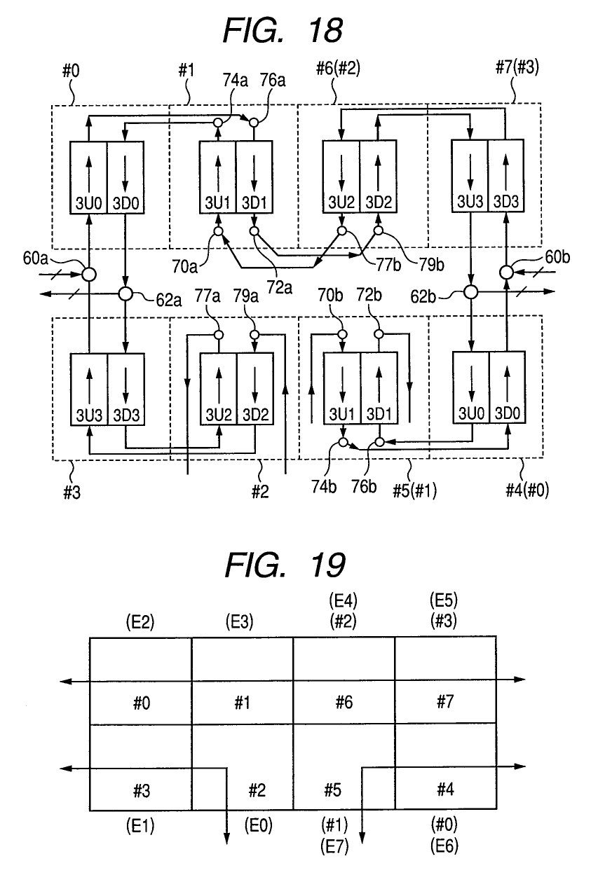

FIG. 18 illustrates an exemplary coupling path of the parallel arithmetic device shown in FIGS. 16 and 17. In FIG. 18, the up inter-ALU coupling switching circuit 3U1 and the down inter-ALU coupling switching circuit 3D1 of the unit block #1 are respectively coupled to the down inter-ALU coupling switching circuit 3D0 and the up inter-ALU coupling switching circuit 3U0 of the unit block #0 via the selectors 74a and 76a, while preserving the data shift direction.

The selectors 70a and 72a respectively couple the up inter-ALU coupling switching circuit 3U1 and the down inter-ALU coupling switching circuit 3D1 of the unit block #1 to the up inter-ALU coupling switching circuit 3U2 and the down inter-ALU coupling switching circuit 3D2 of the unit block #6. Here, in the block #6, rotation is performed and the shift direction of the inter-ALU coupling switching circuit is opposite to the shift direction of the inter-ALU coupling switching circuit in the unit block #1.

The up inter-ALU coupling switching circuit 3U2 and the down inter-ALU coupling switching circuit 3D2 of the unit block #6 are respectively coupled to the down inter-ALU coupling switching circuit 3D3a and the upstream part of the up inter-ALU coupling switching circuit of the unit block #7.

In the unit block #2, on the other hand, the upstream part of the up inter-ALU coupling switching circuit 3U2 is coupled to an adjacent unit block at the time of extension via the selector 77a, and also the upstream part of the down inter-ALU coupling switching circuit 3D2 is coupled to an adjacent unit block at the time of extension via the selector 79a. The inter-ALU coupling switching circuits 3U2 and 3D2 of the unit block #2 are respectively coupled to the inter-ALU coupling switching circuits 3D3 and 3U3 of the unit block #3.

Similarly in the unit block #5, the selector 72a couples the upstream part of the up inter-ALU coupling switching circuit 3U1 to an adjacent unit block at the time of extension, and the selector 72b couples the downstream part of the down inter-ALU coupling switching circuit 3D1 of the unit block #5 to an adjacent unit block at the time of extension. The downstream part of the up inter-ALU coupling switching circuit 3U1 of the unit block #5 is coupled to the upstream part of the down inter-ALU coupling switching circuit 3D0 of the unit block #4 via the selector 74b, and the upstream part of the down inter-ALU coupling switching circuit 3D1 of the unit block #5 is coupled to the downstream part of the up inter-ALU coupling switching circuit 3U0 of the unit block #4.

Therefore, in the case of the coupling path shown in FIG. 18, the unit blocks #0, #1, #6 and #7 are serially coupled as shown in the coupling path of a unit block in FIG. 19, and the unit blocks #2 and #5 are respectively coupled to adjacent unit blocks at the time of extension.

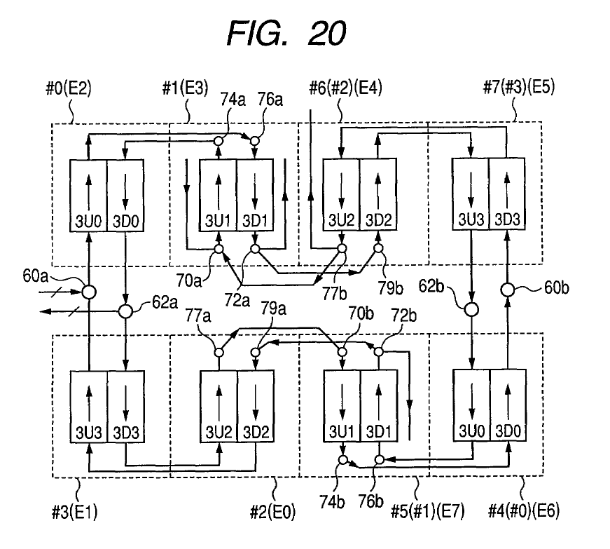

FIG. 20 illustrates a second example of coupling paths of the parallel arithmetic device in this exemplary variation. In the coupling path shown in FIG. 20, the up inter-ALU coupling switching circuit 3U2 of the unit block #2 is coupled to the up inter-ALU coupling switching circuit 3U1 of the unit block #5 via the selectors 77a and 70b, and the upstream part of the down inter-ALU coupling switching circuit 3D2 of the unit block #2 is coupled to the downstream part of the down inter-ALU coupling switching circuit 3D1 of the unit block #5 via the selectors 72b and 79a. The coupling path of the selectors 70a, 72a, 77b, 79b, and 74b and 76b are identical to the coupling path previously shown in FIG. 18.

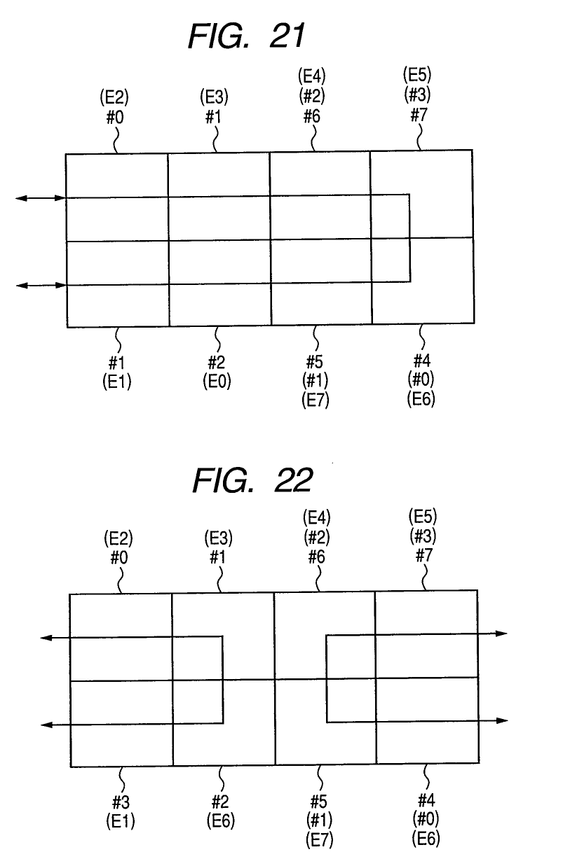

Therefore, as shown in FIG. 21, the unit blocks #0, #1, #6, #7, #4, #5, #2 and #1 are serially coupled in this order, whereby a single basic block is constructed by eight unit blocks. In this 8-unit-block configuration, division and extension coupling of unit blocks can be distinctly identified by assigning the numbers E0-E7 as block numbers.

Here, as shown in FIG. 22, by switching the coupling path of the selectors 70a, 72a, 77a, 79a, 77b, 79b, 70b and 72b, a single basic block can be constructed by four unit blocks #0-#3, and also a single basic block can be constructed by the unit blocks #4-#7. Therefore, a basic block constructed by eight unit blocks can be divided into two basic blocks each being constructed by four unit blocks, as shown in the exemplary couplings in FIGS. 17 and 20, by disposing selectors in the unit blocks #1 and #2 as well.

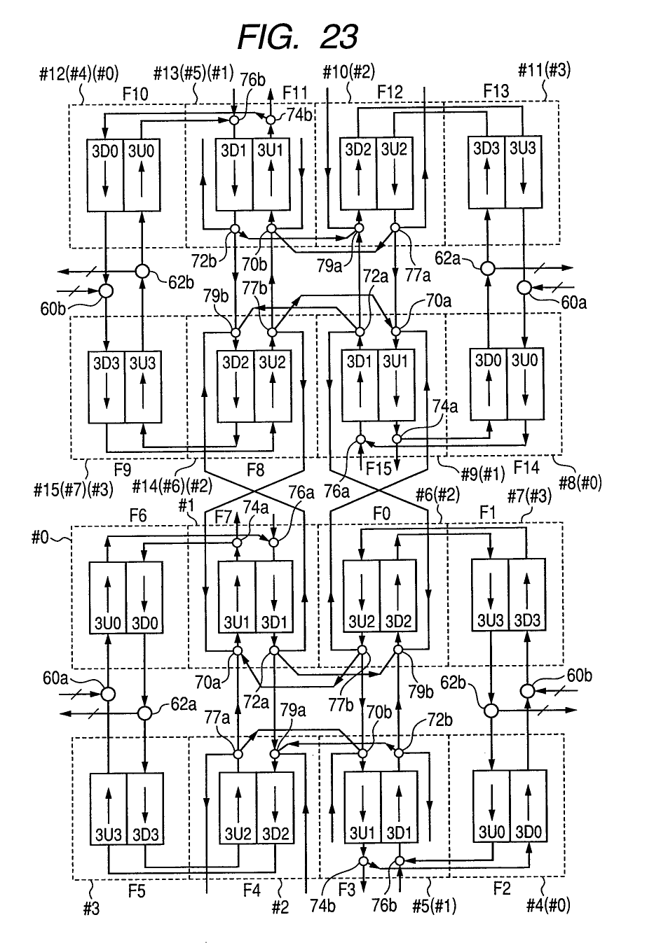

FIG. 23 schematically illustrates coupling paths in a 16-unit-block configuration of the parallel arithmetic device of the exemplary variation of the embodiment 1 of the present invention. In FIG. 23, an additional basic block constructed by 16 unit blocks is formed by further rotating a basic block constructed by the unit blocks #0-#7. In this case, it is arranged so that the first unit block #8 and the last unit block #15 of the newly added basic block are arranged adjacent to the unit blocks #0 and #7. The unit blocks #8-#11 are arranged corresponding to the unit blocks #0-#3, with the unit blocks #4-#7 corresponding to the unit blocks #12-#15. The unit blocks #14 and #9 are arranged adjacent to the unit blocks #1 and #6.

Block numbers are assigned in a manner such that the block numbers are serial in the minimum dividable basic block (four unit blocks), and the block numbers are serial in an adjacent minimum dividable basic block. In FIG. 23, the block numbers F0-F15 are assigned so that the first and the last block numbers are adjacent in minimum dividable basic blocks (minimum size basic blocks) which are adjacent in succession. By such a numbering, block numbers are assigned so that unit blocks are sequentially coupled along a unicursal path.

The numbers of the 16 unit blocks #0-#15 are assigned by rotating to extend the block numbers in the 8-unit-block configuration. The positions of the numbers of unit blocks in a basic block constructed by 16 unit blocks can be freely set. In consideration of dividing into a smaller block size, the block numbers F0-F15 are assigned as mentioned above. In FIG. 23, a block number F0 is assigned to the unit block #6 (#2) and a block number F15 is assigned to the unit block #9 (#1).

In the 16-unit-block configuration, the down inter-ALU coupling switching circuits 3D2 and 3D1 of the unit blocks F8 (#14) and F7 (#1) are mutually coupled via the selectors 79b and 72a. In addition, the up inter-ALU coupling switching circuit 3U2 of the unit block F8 (#14) is coupled to the up inter-ALU coupling switching circuit 3U1 of the unit block F7 (#1) via the selectors 77b and 70a.

Similarly, the up inter-ALU coupling switching circuit 3U2 of the unit block F0 (#6) is coupled to the up inter-ALU coupling switching circuit 3U1 of the unit block F15 (#9) via the selectors 70a and 77b. Similarly, the down inter-ALU coupling switching circuit 3D1 of the unit block F15 (#9) is coupled to the down inter-ALU coupling switching circuit 3D2 of the unit block F0 (#6) via the selectors 72a and 79b.

Since other coupling paths are identical to those previously shown in FIG. 17, identical reference numerals are assigned to corresponding parts, and detailed description thereof is omitted.

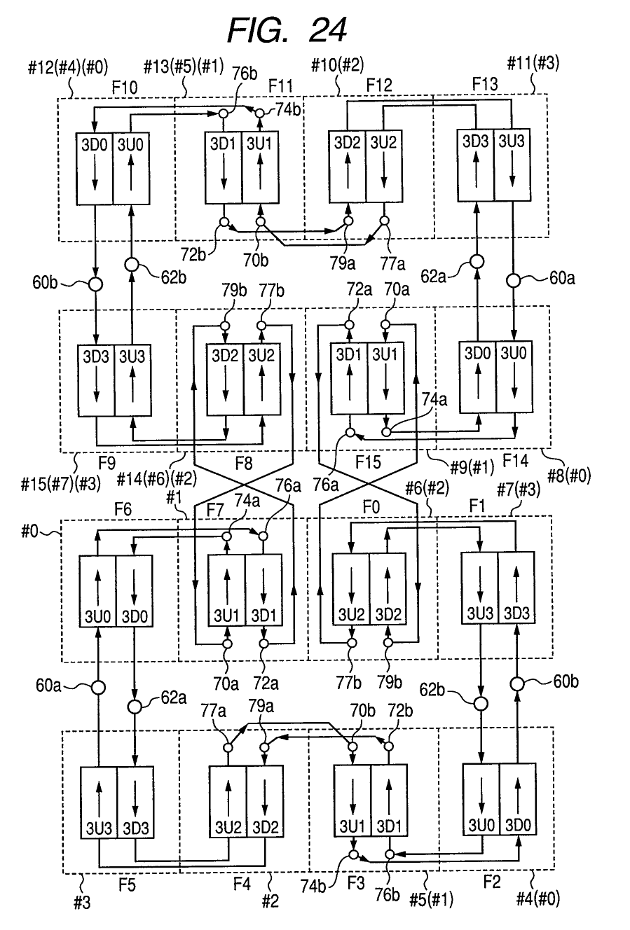

FIG. 24 illustrates coupling paths of the 16 unit blocks shown in FIG. 23. As shown in FIG. 24, the inter-ALU coupling switching circuits 3U2 and 3U1 of the unit blocks #14 and #1 (block numbers F8 and F7) are coupled via selectors, and data transfer path of the down inter-ALU coupling switching circuits 3D2 and 3D1 is coupled via the selectors 72a and 79b. Similarly, the up inter-ALU coupling switching circuits 3U1 and 3U2 of the unit blocks #6 and #9 (block numbers F0 and F15) are mutually coupled via selectors, and the down inter-ALU coupling switching circuits 3D1 and 3D2 are tandemly coupled via selectors.

By the above coupling paths, the unit blocks are sequentially coupled in the order of block numbers F0-F15, thus 16 unit blocks construct a single basic block, and whereby a parallel arithmetic device including 16 unit blocks can be realized.

In the parallel arithmetic device shown in FIG. 24, the internal structure of the parallel arithmetic device of the 16-unit-block configuration can be divided into two basic blocks each constructed by eight unit blocks, and can be divided into four basic blocks each constructed by four unit blocks by switching the coupling path of each selector, as previously described in FIGS. 18 to 22. In each division, the block numbers F0-F15 are serially assigned in the basic block.

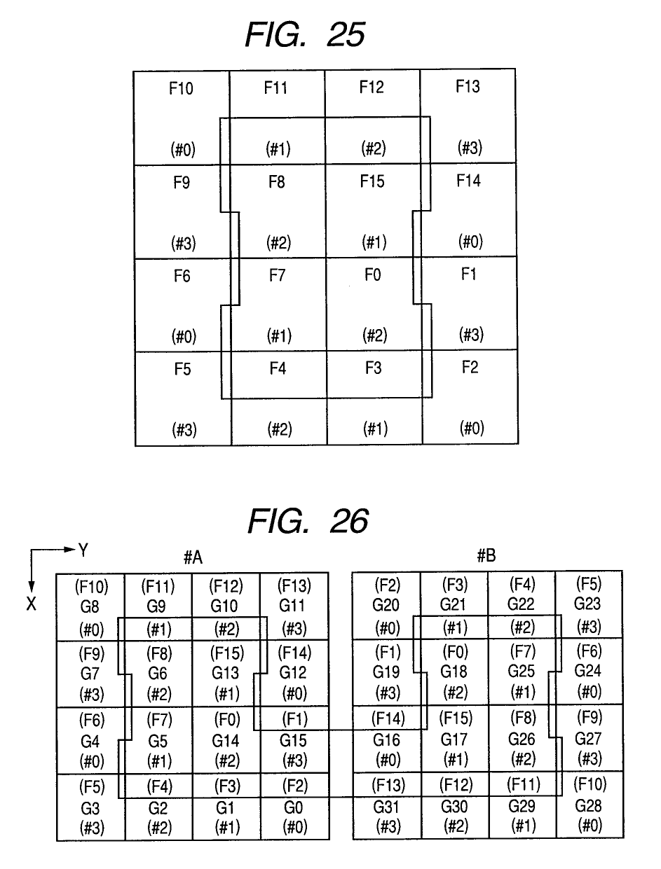

FIG. 25 schematically illustrates a data propagation path of the coupling path of the selector shown in FIG. 24. As shown in FIG. 25, the block numbers F0-F15 are mutually coupled in sequence via the inter-ALU coupling switching circuits. The wiring between unit blocks is provided only between adjacent unit blocks and data transfer is performed between adjacent unit blocks.

Particularly, as shown by the block numbers F7 and F8 in FIG. 25, coupling between the unit blocks #2 and #1 can be realized between basic blocks constructed by adjacent four unit blocks by disposing the selectors so that they can be wire-connected in both the X-direction and Y-direction for the unit blocks #1 and #2 in a basic block (minimum size basic block: minimum dividable basic block) constructed by four unit blocks, and whereby the degree of freedom of coupling of unit blocks of a basic block becomes higher.

FIG. 26 schematically illustrates a block coupling configuration of the parallel arithmetic device constructed by 32 unit blocks using the 16-block configuration shown in FIG. 25. In the configuration shown in FIG. 26, an additional basic block #B is formed and arranged by rotating the basic block #A by 180 degrees. In the basic blocks #A and #B, unit blocks #0-#3 are arranged in alignment in this order (in the Y-direction), whereas in the basic blocks #A and #B, the order of the arrangement of the unit blocks #0-#3 is alternately reversed in the X-direction.

Numbers G0-G31 are used as the block numbers. The block numbers G0-G15 are assigned in the basic block #A, and the block numbers G16-G31 are assigned to the unit blocks in the basic block #B. In this case, numbering is performed so that the block numbers G0 and G15 are adjacent to the block numbers G31 and G16 of the basic block #B, respectively, in the basic blocks #A and #B. In FIG. 26, the block numbers F0-F15 and #0-#3 for a smaller size block configuration is shown in the parenthesis in order to clarify the correspondence among the block numbers of the 32-unit block configuration, the 16-unit block configuration, and the 4-unit block configuration.

In the case of a 32-unit-block configuration shown in FIG. 26, the block numbers G15 and G16 are mutually coupled, and also the unit blocks having block numbers G0 and G31 are mutually coupled to complete a loop of the coupling path. Therefore, in the original block numbers F1 and F2 corresponding to the block numbers G15 and G0, the coupling path of the unit blocks #3 and #0 is switched by the selectors 60 and 62. This is similar in both basic blocks #A and #B. Therefore, in this case, the size of a processor of 32 unit blocks can be reduced to that of a processor of 16 unit blocks by simply switching the coupling between the unit blocks bearing the block numbers G15 and G16, and the coupling between the unit blocks bearing the block numbers G0 and G31.

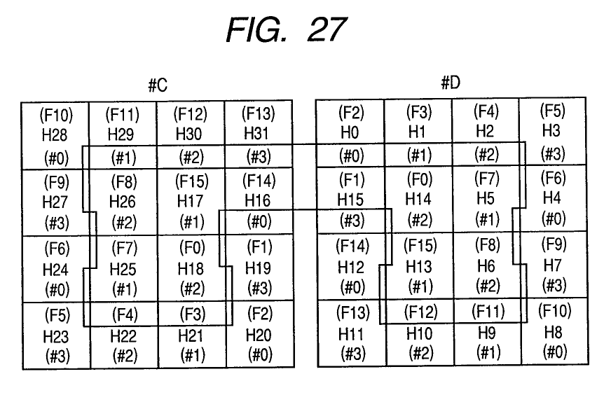

FIG. 27 illustrates an exemplary variation of the coupling of the parallel arithmetic device of the 32-unit block configuration. In FIG. 27, the basic blocks #C and #D are obtained by rotating the basic blocks #A and #B shown in FIG. 26. In this case, respective block numbers H0-H31 are assigned so that the first and the last block numbers of the basic blocks #C and #D correspond to each other in an intersecting manner (the block numbers are assigned so that the first and the last block numbers are adjacent).

In the case shown in FIG. 27, the unit blocks having block numbers H31 and H0 (#3 and #0) are mutually coupled using the selectors (60 and 62). By this mutual coupling, the mutual coupling of the unit blocks (#3 and #0) having block numbers H31 and H16 is separated, and the mutual coupling of the unit blocks (#0 and #3) having block numbers H0 and H15 is separated in the basic block #D as well. The unit blocks having block numbers H16 and H15, and the unit blocks of having block numbers H0 and H31 are mutually coupled, respectively, by manipulating the selectors 60 and 62.

In the above-mentioned manner, a basic block constructed by 32 unit blocks can be realized, and the 16 unit blocks can be divided into a smaller-sized basic block constructed by 8-unit blocks or 4-unit blocks. This is because, in the unit blocks #1 and #2, it becomes possible to mutually couple the unit blocks #1 and #2 of the minimum size basic block adjacent in the Y-direction.

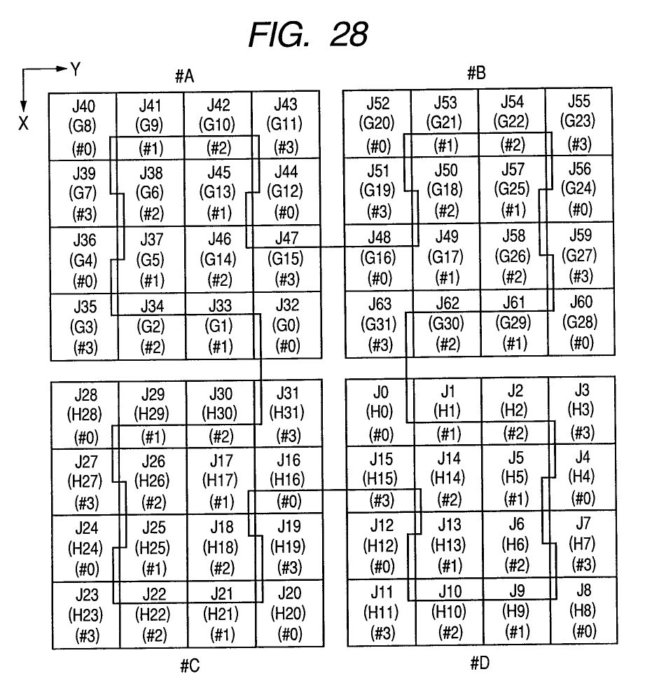

FIG. 28 illustrates the basic block configuration of an exemplary variation of the embodiment 1 of the present invention. An exemplary arrangement of the coupling of the basic block of 64 unit blocks is shown in FIG. 28. In FIG. 28, the basic block constructed by these 64 unit blocks is equivalent with the arrangement in which the basic blocks #A, #B, #C and #D shown in FIGS. 26 and 27 are coupled. In other words, numbers J32-J63 are assigned to the block numbers G0-G31 in the basic blocks #A and #B. Numbers J0-J31 are assigned to the unit blocks having block numbers H0-H31 of the basic blocks #C and #D. The unit blocks (#0, #3) bearing the block numbers J32 and J63 are separated, and the unit block bearing the block number J32 is coupled to the unit block (#3) bearing the block number J31. Similarly, the unit block (#3) bearing the block number J63 is coupled to the unit block (#0) bearing the block number J0.

Therefore, a basic block constructed by 64 unit blocks is realized by mutually coupling 32 unit blocks.

The basic block constructed by these 64 unit blocks can be therefore divided into two basic blocks each constructed by 32 unit blocks, and four basic blocks each constructed by 16 unit blocks. In this case, the first and the last numbers of the unit blocks in the basic block at the time of reduction are arranged so as to be respectively adjacent to the last and the first block numbers of an adjacent reduced basic block.

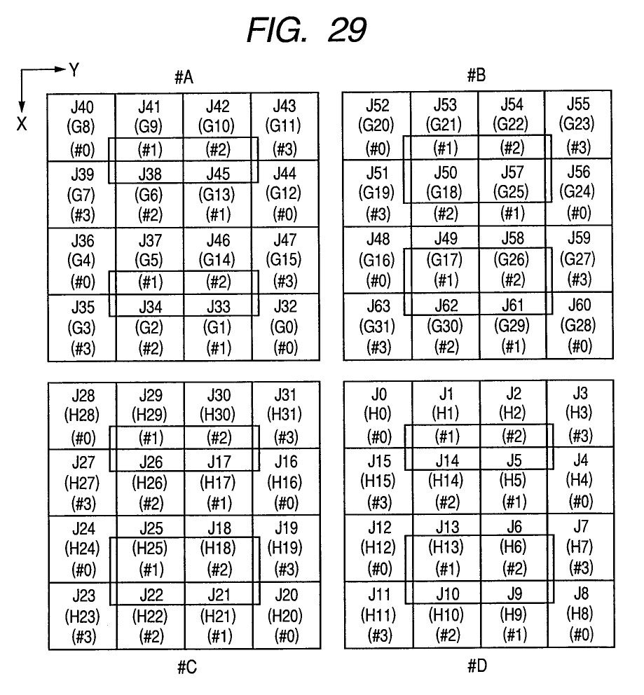

FIG. 29 schematically illustrates the data propagation path when the basic block of 64 unit blocks shown in FIG. 28 is divided into basic blocks of eight unit blocks. As shown in FIG. 29, by coupling the unit blocks #1 and #2 which are adjacent in the Y-direction instead of the coupling path of the unit blocks #1 and #2 which are aligned in the X-direction, the unit blocks #1 and #2 can be divided into eight basic blocks constructed by eight unit blocks serially numbered.

Therefore, a basic block of 64 unit blocks can be sequentially reduced and divided as small as a basic block of four unit blocks by arranging the unit blocks #1 and #2 in a basic block constructed by four unit blocks so that they can be coupled both in the X-direction and the Y-direction.

As described above, according to the embodiment 1 of the present invention, a plurality of unit blocks is arranged to configure a basic block, the basic block is divided into smaller blocks so that the first and the last numbers of the serial numbers of unit blocks in the smaller blocks are adjacent, and selectors are provided corresponding to the boundary region of this small block division. In this manner, a data transfer wiring is provided only between adjacent unit blocks to perform data transfer, and whereby wiring delay is reduced. In addition, it suffices to simply switch the path of the selectors without having to provide wirings for various directions between respective basic blocks, and whereby wiring layout area is reduced. In addition, only selectors are required for the circuitry to change the block size, whereby the configuration for switching the processor (parallel arithmetic device) function (configuration) is simplified, and the occupied area can be reduced.

### Embodiment 2

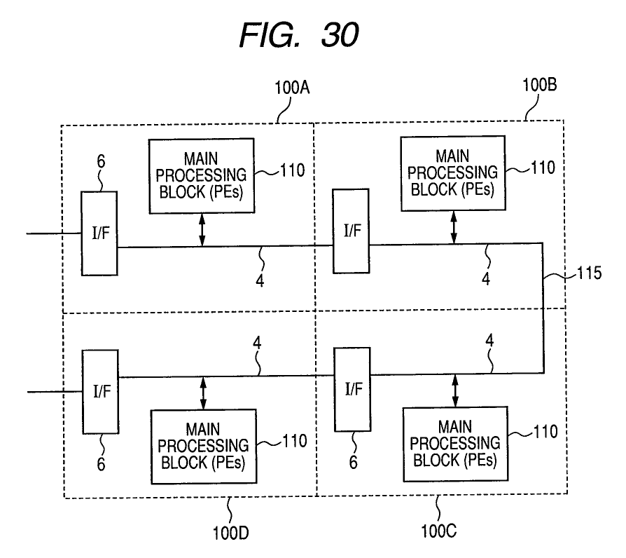

FIG. 30 schematically illustrates a configuration of the minimum basic block of a parallel arithmetic device according to an embodiment 2 of the present invention. In FIG. 30, the parallel arithmetic device includes four unit blocks 100A-100D. Each of these unit blocks 100A-100D includes a main processing block 110, an internal data bus 4, and a bus interface (I/F) 6. The main processing block 110 includes a register circuit, an inter-ALU coupling switching circuit, and processing units (PEs) 2 shown in FIG. 1, and can perform data transfer with the internal data bus 4.

In the arrangement shown in FIG. 30, the internal buses 4 of the unit blocks 100B and 100C are mutually connected by an extended wiring 115. The basic block constructed by the unit blocks 100A-100D shown in FIG. 30 is used as the minimum dividable basic block of a basic block.

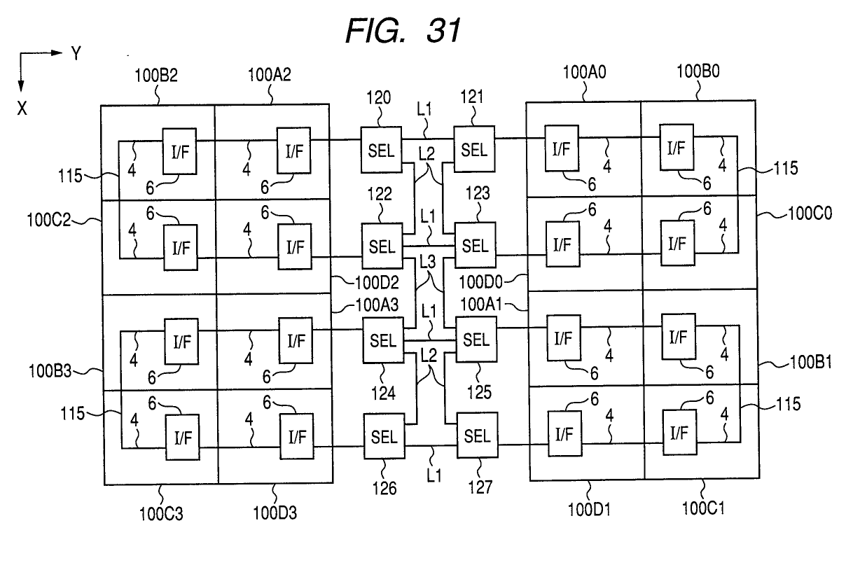

FIG. 31 illustrates a part of the configuration of the basic block (parallel arithmetic device) according to the embodiment 2 of the present invention. In FIG. 31, the basic block includes 16 unit blocks 100A0-100A3, 100B0-100B3, 100C0-100C3, and 100D0-100D3. The minimum dividable basic block (minimum size basic block) is formed by unit blocks 100Ai, 100Bi, 100Ci and 100Di. Here, i is an integer ranging from 0 to 3.

Since the internal configuration of the unit blocks 100Ai-100Di is identical to that shown in FIG. 30, identical reference numerals are assigned to corresponding parts, and detailed description thereof is omitted.

In the case of this arrangement, a selector (SEL) is provided corresponding to each unit block in the boundary region of a minimum size basic block in the Y-direction. In FIG. 31, selectors 121, 123, 125 and 127 are arranged corresponding to unit blocks 100A0, 100D0, 100A1 and 100D1, respectively. Selectors 120, 122, 124 and 126 are arranged corresponding to unit blocks 100A2, 100D2, 100A3 and 100D3, respectively.

Selectors oppositely arranged in the Y-direction are mutually connected by a wiring L1. Then, other ports of the selectors adjacent in the X-direction are mutually connected by a wiring L2. For selectors 122, 123, 124 and 125 corresponding to the boundary region of the minimum size basic block in the X-direction, a wiring L3 is further provided and yet other ports of the selectors adjacent to in the X-direction are mutually connected.

By switching the coupling path of the selectors 120-127, a basic block of 16 unit blocks, a basic block of eight unit blocks, and a basic block of four unit blocks can be realized. In other words, in each of the selectors (SEL) 120-127, four basic blocks of four unit blocks can be arranged by selecting a port to be connected to the wiring L2 and coupling it to a corresponding interface (I/F). In the selectors 120-127, two basic blocks constructed by eight unit blocks can be arranged by selecting a port to be connected to the wiring L1 and coupling it to the corresponding bus interface (I/F) 6.

The selectors 120 and 121 select a port to which the wiring L1 is connected, and the selectors 122, 123, 124 and 125 select a port to which the wiring L3 is connected, and the selectors 126 and 127 select a port to which the wiring L1 is connected. In this manner, a basic block can be constructed by 16 unit blocks.

Therefore, also with the arrangement shown in FIG. 31, a large scale basic block can be sequentially divided into smaller basic blocks by disposing, in the boundary region of respective minimum size basic unit blocks, selectors corresponding to the unit blocks and switching the data propagation path by switching the ports of the selectors, or on the contrary, a large scale basic block can be constructed by repetitively disposing smaller size basic blocks.

### Exemplary Variation

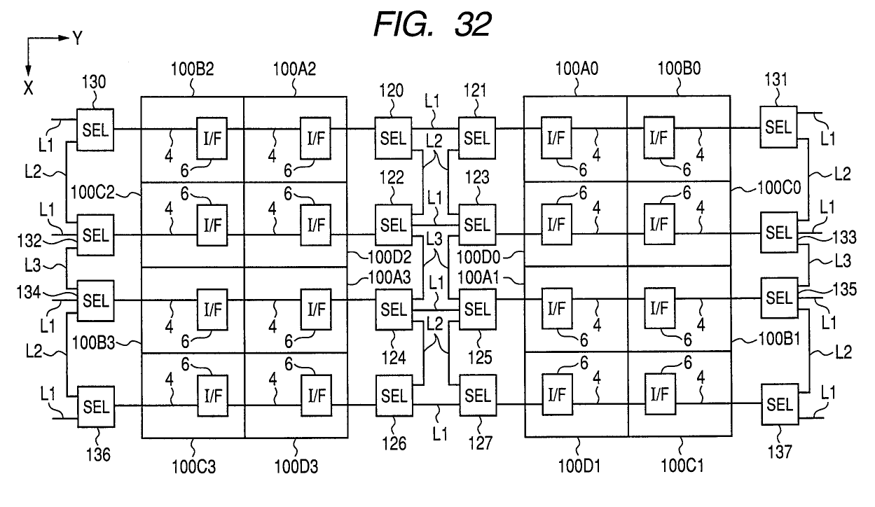

FIG. 32 schematically illustrates the arrangement of an exemplary variation of the parallel arithmetic device according to the embodiment 2 of the present invention. In the arrangement shown in FIG. 32, the minimum dividable basic block includes four unit blocks similarly with the configuration previously shown in FIG. 31. In the configuration shown in FIG. 32, unlike the configuration shown in FIG. 31, selectors are further arranged symmetrically with the selectors 120-127 in the boundary region of the minimum dividable basic block along the Y-direction. In other words, selectors 131, 133, 135 and 137 are arranged for the internal data bus 4 in correspondence with the unit blocks 100B0, 100C0, 100B1 and 100C1.

For selectors adjacent in the X-direction, their ports are connected by a wiring L2, and a wiring L1 is provided to further extend adjacent unit blocks in the unshown Y-direction. In order to enable the unit blocks 100C0 and 100B1 of the minimum dividable basic block to be coupled in this X-direction, the third ports of the selectors 133 and 135 are further mutually coupled by the wiring L3.

Here, for the unit blocks 100B2, 100C2 and 100B3, selectors 130, 132, 134 and 136 are arranged for the internal data bus 4 symmetrically with the selectors 120, 122, 124 and 126. With regard to these selectors, the first ports of the selectors adjacent in the X-direction are mutually connected by a wiring L2, and the first ports are connected to the wiring L1 to couple with unit blocks for extension adjacent in the Y-direction. The third ports of the selectors 132 and 134 provided in the boundary region of the minimum dividable basic block are mutually connected by a wiring L3.

By repetitively disposing the arrangement shown in FIG. 32 in the X-direction and the Y-direction, the number of unit blocks constructing the parallel arithmetic device can be extended, with the block size of the minimum dividable basic block being a 4-unit block. On the contrary, a parallel arithmetic device constructed by a large-scale basic block can be reduced by switching the coupling path of the selectors 120-127 and 130-137 to a basic block of a smaller block size.

If the selectors 120-127 and 130-137 have a path interrupting function that interrupts a path between corresponding unit blocks, the minimum size basic block can be constructed by two unit blocks, in the configuration shown in FIG. 32.

As thus described, selectors are provided corresponding to respective unit blocks in the boundary region in one direction (Y-direction) of the minimum dividable basic blocks of the embodiment of the present invention, and coupling paths of the selectors are set for a required basic block size. In this manner, a large sized parallel arithmetic device can be divided into basic blocks of a small block size without increasing the wiring area. Additionally, also in this case, a data propagation path exists only between adjacent unit blocks, and whereby wiring propagation delay can be avoided.

### Embodiment 3

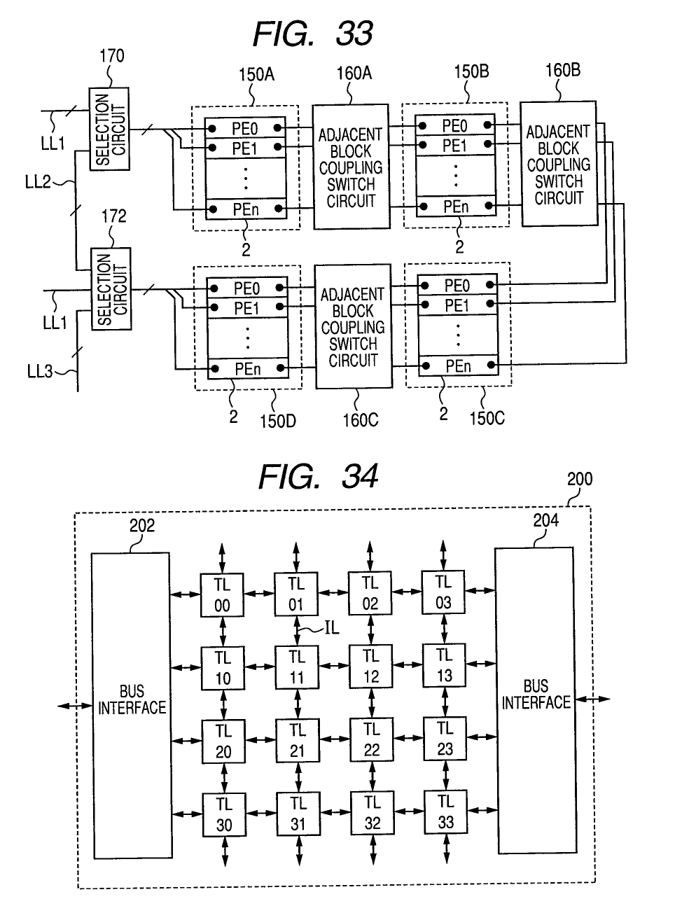

FIG. 33 schematically illustrates a configuration of the minimum dividable basic block of a parallel arithmetic device according to an embodiment 3 of the present invention. In FIG. 33, four unit blocks 150A-150D are provided. Each of the unit blocks 150A-150D has a configuration shown in FIG. 1 and the configuration of the processing unit 2 included in these unit blocks 150A-150D is shown representatively in FIG. 33. The processing unit 2 includes a plurality of processing elements PE0-PEn.

Adjacent block coupling switch circuits 160A-160C are arranged between the unit blocks 150A-150D. The adjacent block coupling switch circuit 160A couples the processing elements PE0-PEn of the unit blocks 150A and 150B in a one to one manner. An adjacent block coupling switch circuit 160B couples processing elements PE0-PEn of the unit blocks 150B and 150C in a one to one manner. An adjacent block coupling switch circuit 160C couples the processing elements PE0-PEn of the unit blocks 150C and 150D in a one to one manner.

Since the minimum dividable basic block includes the four unit blocks 150A-150D, selection circuits 170 and 172 are provided corresponding to the unit blocks 150A and 150D in their boundary region. The first port of the selection circuit 170 is coupled to a unit block oppositely arranged at the time of extension via a multi-bit wiring LL1, and the second port is coupled to the first port of the selection circuit 172 via a multi-bit wiring LL2. The selection circuit 170 has a wiring and a switch circuit (or driver) coupled to the processing elements PE0-PEn of the unit block 150A, and has data transfer control functionality.

The selection circuit 172 is connected to a unit block oppositely arranged at the time of extension via a multi-bit wiring LL1, and also connected to a selection circuit arranged in a unit block provided in the downward direction of FIG. 33 at the time of extension via a multi-bit wiring LL3. The selection circuit 172 has a wiring coupled to the processing elements PE0-PEn of the unit block 150D, and has data transfer control functionality.

In the case of the configuration shown in FIG. 33, data transfer can be performed by a unit of the processing unit 2. By disposing a plurality of configurations shown in FIG. 33, 16 unit blocks can construct a single basic block and the 16 unit blocks can be divided into 8 unit blocks and further into 4 unit blocks, as with the configuration previously shown in the embodiment 2, for example similarly with the configuration shown in FIG. 31.

Here, in the configuration shown in FIG. 33, an configuration similar to that shown in FIG. 32 can be realized by providing selection circuits corresponding to the unit blocks 150B and 150C instead of the adjacent block coupling switching circuit 160B, and providing a wiring similar to the wiring for the selection circuits 170 and 172, and whereby a basic block constructed by unit blocks of a larger scale can be realized. In addition, the minimum dividable basic block size of this large-scale basic block can be set to the 4-unit block.

Additionally, with regard to the selection circuit 170, the coupling with the selection circuit provided for a unit block adjacent to the upper part of the figure may be formed by another wiring. Furthermore, a large-scale basic block can be constructed.

### Exemplary Variation

FIG. 34 schematically illustrates the configuration of an exemplary variation of the parallel arithmetic device of the embodiment 3 of the present invention. In FIG. 34, a unit block 200 includes a plurality of tile-like processor cores TL arranged in a matrix. FIG. 34 shows, as an example, processor cores TL00-TL03 to TL30-TL33 which are arranged as a 4×4 matrix. The processor cores TL00-TL03 to TL30-TL33 are mutually connected by a network wiring IL arranged in a mesh. The network wiring IL connects adjacent processor cores.

Bus interfaces 202 and 204 are provided on both sides of the processor cores. The bus interface 202 can perform two-way communication with the processor cores TL00, TL10, TL20 and TL30, and the bus interface 204 can perform two-way communication with processor cores TL03, TL13, TL23 and TL33. In this mesh-like network wiring, the processor cores TL00-TL03 at the first row can perform two-way communication with an unshown memory, and also the processor cores TL30-TL33 at the bottom row can perform two-way communication with an unshown memory.

Using the unit block 200 having a plurality of processor cores (multi-core processor) as shown in FIG. 34, a large-scale basic block (parallel arithmetic device) is constructed.

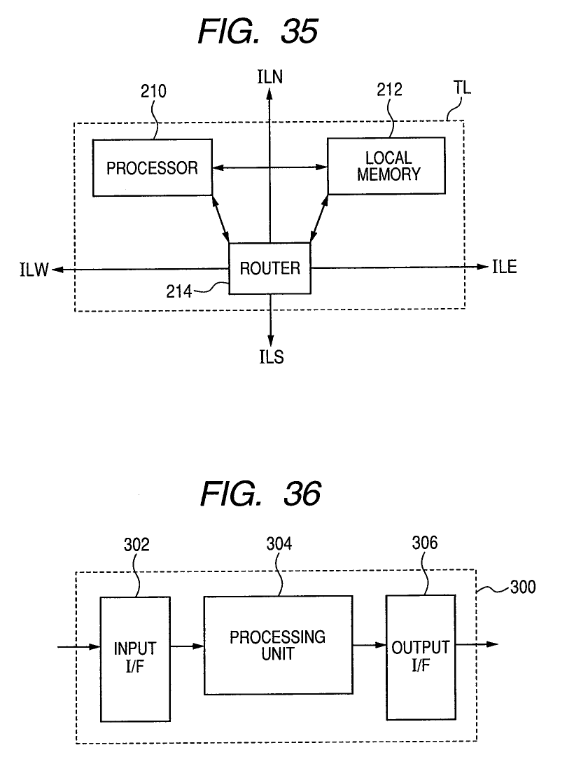

FIG. 35 schematically illustrates an exemplary configuration of the processor cores shown in FIG. 34. Since the processor cores TL00-TL03, . . . TL30-TL33 have an identical configuration, the processor core TL in FIG. 35 representatively depicts the configuration of the processor cores TL00-TL03, . . . TL30-TL33.

In FIG. 35, the processor core TL includes a processor 210, a local memory 212, and a router 214. The processor, 210, which is capable of two-way communication with the local memory 212, accesses the local memory 212, retrieves instructions and data, and performs arithmetic processing. Both the processor 210 and the local memory 212 are coupled to the router 214. The router 214 is coupled to routers of the processor core adjacently arranged in four directions by wirings ILN, ILE, ILS and ILW included in the network wiring IL. Since the wiring is arranged so that communication is performed only between adjacent processor cores, tangle of wiring as well as propagation delay of data communication signals can be avoided.

Also in such a multi-core processor including a plurality of processor cores, the number of required processor cores and the granularity of processing differ as necessary. Therefore, in a large-scale basic block, a large-scale basic block can be divided into a basic block of a smaller scale by selectively coupling the unit blocks using the selectors as shown in FIG. 31 or 32, and whereby a processor of a scale suitable for the granularity of processing can be realized.

Also in this configuration, communication is performed only between adjacent unit blocks, and wirings between unit blocks are only those between adjacent unit blocks, and whereby increase of wiring area for changing the block size can be suppressed.

### Exemplary Variation 2

FIG. 36 schematically illustrates the configuration of a unit block of an exemplary variation 2 of the embodiment 3 of the present invention. In FIG. 36, a unit block 300 includes a processing unit 304, and an input interface (I/F) 302 and an output interface (I/F) 306 respectively provided at the input part and the output part of the processing unit 304.

In the unit block 300, the flow of data/signal is one-way from the input interface 302 to the output interface 306. Also in the case where the flow of data/signal is one-way in the unit block 300, a large-scale basic block with a variable block size can be formed by disposing a plurality of the unit blocks 300 and selectively coupling the unit blocks 300 using selectors as shown in FIGS. 31 to 33. For example, in a configuration where arithmetic processing is performed in a pipeline manner, the number of stages of the pipeline can be adjusted by changing the size of the basic block.

The arrangement of selectors and coupling therebetween, and the numbering order of unit blocks are similar to the embodiments 1 and 2.

As thus described, according to the embodiment of the present invention, a large size basic block is constructed by selectively coupling unit blocks via selectors. Therefore, wirings between blocks are only those between adjacent blocks, whereby the area occupied by wirings and data propagation delay can be reduced, and a multi-core processor of a required size can be realized as well.

### Embodiment 4

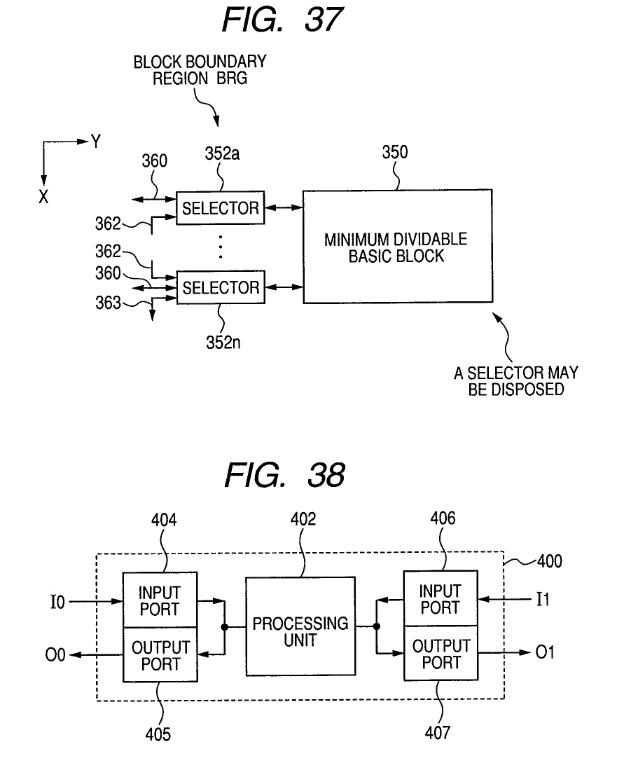

FIG. 37 schematically illustrates a method of constructing a basic block according to an embodiment 4 of the present invention. In FIG. 37, the arrangement of selectors for a minimum dividable basic block 350 is shown representatively. In a block boundary region BRG of the minimum dividable basic block 350, selectors 352a-352n are provided corresponding to the unit blocks included in the minimum dividable basic block 350. For each of the selectors 352a-352n, those adjacent in the X-direction are connected using a wiring 362. In addition, the selectors 352a-352n and a selector of a unit block oppositely arranged thereto with regard to the block boundary region BRG (with regard to the Y-direction) are connected by a wiring 360. Coupling to selectors arranged for adjacent unit blocks of the minimum dividable basic block beyond the block boundary region in the X-direction is provided by a wiring 363.

By repetitively disposing, as a basic configuration, the configuration shown in FIG. 37 in the X-direction, and disposing in reflective symmetry in the Y-direction, a basic block of the required size can be realized. Here, in another block boundary regions oppositely arranged with regard to the block boundary region BRG in the Y-direction, selectors may be provided similarly with the selectors 352a-352n. In this case, a basic block of the required size can be realized by repetitively disposing the minimum dividable basic block in the X-direction and the Y-direction.

### Exemplary Variation of Block Configuration

FIG. 38 schematically illustrates the configuration of an exemplary variation of a unit block used in the block configuration of the basic block according to the embodiment 4 of the present invention. In FIG. 38, the unit block 400 includes a processing unit 402, input ports 404 and 406 oppositely provided on both sides of the processing unit 402, and output ports 405 and 407 arranged adjacent to the input ports 404 and 406, respectively.

Input data/signals I0 and I1 are respectively provided to the input ports 404 and 406, and the outputs ports 405 and 407 output the output data/signals O0 and O2, respectively. In the case of the configuration shown in FIG. 38, the data/signal transmitted from one side in the unit block 400 is output via a port arranged at the other side. For example, the data input from the input port 404 is output via the output port 407 after being processed in the processing unit 402. Also in the case of this configuration, it is possible to set the data flow in a selected basic block to be one-way by disposing the selectors similarly with the case of the embodiment 1, as will be described below.

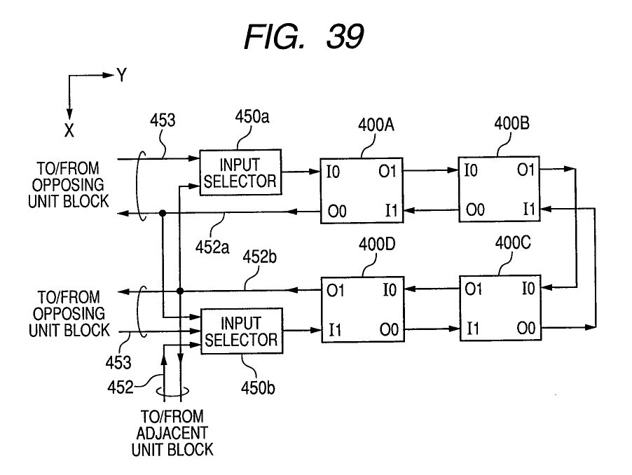

FIG. 39 schematically illustrates the configuration of the exemplary variation of the basic block of the embodiment 4 of the present invention. In FIG. 39, the minimum dividable basic block includes unit blocks 400A-400D. The unit blocks 400A-400D have a similar configuration as with the unit block 400 shown in FIG. 38. In FIG. 39, an input port and an output port are indicated by data/signals I0, I1, O0 and O1 of FIG. 38, respectively.

In the configuration shown in FIG. 39, an input selector 450 is arranged, corresponding to the input port of the unit block, in the boundary region of the minimum dividable basic block in the Y-direction. In FIG. 39, an input selector 450a is arranged corresponding to the input port I0 of the unit block 400A, and an input selector 450b is arranged corresponding to the input port of the unit block 400D. The output ports O0 and O1 of the unit blocks 400A and 400D are joined to an input selector adjacently provided and an input selector provided for the input port of the unit block oppositely arranged in the Y-direction, via wirings 452 (452a, 452b). Thus, in FIG. 39, the output wiring 452a from the unit block 400A is connected to the input part of the input selector 452b provided for the unit block 400D adjacent in the X-direction, and is also coupled to the input selector of the unit block oppositely arranged in the Y-direction. Additionally, the output wiring 452 (452c) from a unit block which is further adjacent in the X-direction to the output wiring 453 from an opposing unit block is coupled to the input selector 450b.

Additionally, the output wiring 453 from an opposing unit block and the output wiring 452b of the adjacent unit block 400D are coupled to the input selector 450a. In the minimum dividable basic block opposing with regard to the Y-direction, a minimum dividable basic block is arranged by arranging the arrangement shown in FIG. 39 in a rotationally symmetric arrangement.

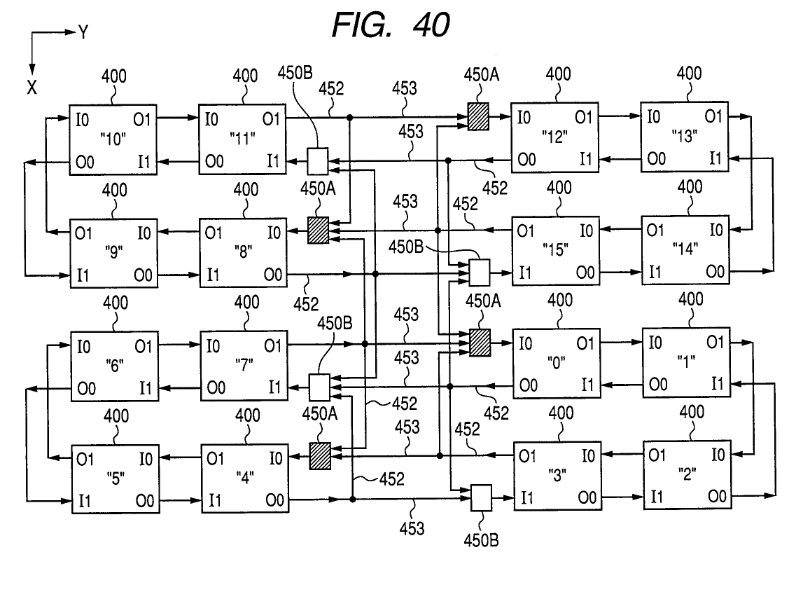

FIG. 40 schematically illustrates the coupling when the basic block includes 16 unit blocks using the configuration of the minimum size basic block shown in FIG. 39. In FIG. 40, unit blocks 400 are arranged as a 4×4 matrix. The minimum dividable basic block includes four unit blocks 400.

The input selectors 450A and 450B are alternately arranged in the boundary region in the Y-direction of the minimum dividable basic block. In this case, the output wiring 452 of a unit block is coupled to the selector 450 (450A or 450B) provided for a unit block which is adjacent in the X-direction in the block boundary region, and is also coupled, as an opposite wiring 453, to the selector 450 (450A or 450B) provided for a unit block oppositely arranged in the Y-direction.

With regard to the coupling of the unit blocks 400, the unit blocks 400 are mutually coupled so that the input ports I0 and the output ports O1 are alternately arranged, and the input ports I1 and the output ports O0 are alternately arranged. The input selector 450A is coupled to the input port I0 and the input selector 450B is coupled to the input port I1.

Block numbers are assigned to the unit blocks 400 so that the block numbers in the minimum size basic block are serial, and the numbers of the unit blocks of the basic block at the time of reduction are provided so that the blocks bearing the first and the last numbers are adjacent. In FIG. 40, block numbers 0 to 15 are assigned to the unit blocks 400 so that a closed loop can be formed by unit blocks having serial numbers, in other words, the unit blocks are coupled by a unicursal coupling path.

In the coupling configuration of the selectors, a path is formed which transfers data in a clockwise direction when the selector 450A is used, whereas a path is formed which transfers data in a counterclockwise direction, by using the selector 450B. By switching the coupling path of the selector 450A or 450B, the basic block of 16 unit blocks can be divided into a basic block of 8 unit blocks or a basic block of 4 unit blocks.

The arrangement of the selectors shown in FIG. 40 can construct a large size basic block by extending the minimum size basic block in the X-direction. However, in the arrangement shown in FIG. 40, a wiring may be provided by similarly disposing a selector in the boundary region of another minimum dividable basic block in the Y-direction, and also applying a rule of coupling the output wiring to the input selector of an adjacent unit block and coupling it to an input selector arranged for a unit block opposite with regard to the Y-direction. In the case of this configuration, minimum size blocks can be repetitively arranged in the X- and the Y-directions, similarly with the configuration shown in FIG. 17, and whereby a basic block of a larger scale can be realized. In addition, the large scale basic block can be changed into a small size basic block by switching the coupling path of the selectors without changing the wiring layout.

As thus described according to the embodiment 4 of the present invention, when the basic block is constructed by a plurality of unit blocks, selectors are arranged in the boundary regions of the minimum dividable basic blocks, and the output wiring of the unit block of each of the boundary regions is coupled to the input selector of an adjacent unit block and the input selector of an oppositely arranged unit block. In this manner, a basic block of a desired size can be realized, and the large-scale basic block can be changed into a smaller basic block without changing the wiring layout.

In the foregoing embodiments 1 to 4, the minimum size basic block includes four unit blocks. However, the minimum size basic block (minimum dividable basic block) may include two unit blocks. Also in this case, the arrangement of selectors is based on the above-mentioned regularity.

Generally, by applying the present invention to a parallel arithmetic device, a parallel arithmetic device which operates at a high speed and reduces wiring layout area can be realized. The processing element included in the unit blocks of the parallel arithmetic device may be of any configuration provided that it has a processing functionality.

What is claimed is:

1. A parallel arithmetic device comprising:
a basic block including a plurality of unit blocks arranged in an array in a first and a second direction,
wherein the basic block is dividable into a plurality of minimum dividable basic blocks, and adjacent unit blocks are coupled by a wiring in the minimum dividable basic block; and
wherein the basic block includes:
a plurality of selectors each provided corresponding to a unit block of each of the minimum dividable basic block in a boundary region of the minimum dividable basic block in the first direction and switching a coupling path of the corresponding unit block according to a block size; and
a wiring which couples, among the selectors, those provided for unit blocks adjacently arranged in the first and second directions.

2. The parallel arithmetic device according to claim 1, wherein each of the unit blocks has a data input part and a data output part, the selector is provided corresponding to the input part of a corresponding unit block, and the wiring is provided so as to couple the data output part of the corresponding unit block to a selector of a unit block adjacent in the first and second directions.

3. The parallel arithmetic device according to claim 1, wherein the selector establishes a wire connection path according to the block size so that the wiring has a coupling path which is identical to the coupling path when coupling all of the unit blocks in each of the minimum dividable basic blocks except the wire connection path between adjacent unit blocks at one place in the minimum dividable basic block.

4. The parallel arithmetic device according to claim 1,
wherein the basic block includes Nth power of 2 unit blocks,
wherein each of the Nth power of 2 unit blocks is dividable into reduced basic blocks including (N−1)th power of 2 unit blocks,
wherein the selector selects a wiring so that the wiring layout of the unit blocks maintains a wire connection path except adjacent unit blocks between adjacent reduced basic blocks, and
wherein the two reduced basic blocks have an identical mode of wire connection path, when independently used to configure a smaller scale parallel arithmetic device.

5. The parallel arithmetic device according to claim 4,
wherein block numbers are sequentially assigned to unit blocks along the coupling path in each of the reduced basic blocks, and
wherein a wire connection path is formed in the basic block so that, in the two reduced basic blocks, unit blocks bearing the first and the last block numbers of the unit blocks of the first reduced basic block are respectively arranged adjacent to unit blocks bearing the last and the first block numbers of the second reduced basic block.
